(19) United States
(12) Patent Application Publication
(10) Pub. No.: US 2026/0311623 A1
(43) Pub. Date: Oct. 8, 2026

(54) DRIVING CIRCUIT, DRIVING MODULE, DRIVING METHOD, AND DISPLAY DEVICE

(71) Applicants: HEFEI BOE JOINT TECHNOLOGY CO., LTD., Hefei, Anhui (CN); BOE TECHNOLOGY GROUP CO., LTD., Beijing (CN)

(72) Inventors: Xuehuan FENG, Beijing (CN); Yongqian LI, Beijing (CN)

(73) Assignees: HEFEI BOE JOINT TECHNOLOGY CO., LTD., Hefei, Anhui (CN); BOE TECHNOLOGY GROUP CO., LTD., Beijing (CN)

(21) Appl. No.: 19/481,579

(22) PCT Filed: Mar. 6, 2025
(86) PCT No.: PCT/CN2025/080876

§ 371 Date: Nov. 5, 2025

(30) Foreign Application Priority Data
Apr. 26, 2024 (CN) 202410518951.1

(51) Int. Cl. G09G 3/20

(52) U.S. Cl. CPC G09G 3/20; G09G 2330/02

(57) ABSTRACT

A driving circuit, a driving module, a driving method, and a display device. The driving circuit includes a first control node control circuit, a first node control circuit, a second control node control circuit, and a second node control circuit, where the first control node control circuit controls connection between a first control node and an input terminal under control of a control clock signal, the first node control circuit controls connection between the first control node and a first node under control of a first voltage signal, the second control node control circuit controls a potential of a second control node under control of a signal provided by a node control terminal, and the second node control circuit controls a potential of a second node according to the control clock signal under control of the second control node. The present disclosure enables complete reset of the second control node, thereby eliminating potential distortion of a driving signal output from the driving circuit.

### CROSS-REFERENCE TO RELATED APPLICATION

The present application claims priority to Chinese Patent Application No. 202410518951.1 filed in China on Apr. 26, 2024, the entire contents of which are incorporated herein by reference.

### TECHNICAL FIELD

The present disclosure relates to the field of display technologies, and in particular, to a driving circuit, a driving module, a driving method, and a display device.

### BACKGROUND

In the display field, especially in OLED (Organic Light-Emitting Diode) displays, oxides are currently widely used in medium and large-sized OLED displays due to their good uniformity. Internal compensation has attracted wide attention because of its low cost and good compensation effect. The related internal compensation driving circuit cannot completely reset the second control node, failing to eliminate the potential distortion in the driving signal output by the driving circuit.

### SUMMARY

The present disclosure primarily aims to provide a driving circuit, a driving module, a driving method, and a display device, so as to solve the problem in the prior art that the second control node cannot be completely reset and the potential distortion in the driving signal output by the driving circuit cannot be eliminated.

In one aspect, an embodiment of the present disclosure provides a driving circuit, which includes a first control node control circuit, a first node control circuit, a second control node control circuit, and a second node control circuit, where
the first control node control circuit is electrically connected to a control clock signal terminal, an input terminal, and a first control node, and is configured to control the connection between the first control node and the input terminal under the control of a control clock signal provided by the control clock signal terminal,
the first node control circuit is electrically connected to a first voltage terminal, the first control node, and a first node, and is configured to control the connection between the first control node and the first node under the control of a first voltage signal provided by the first voltage terminal,
the second control node control circuit is electrically connected to a node control terminal and a second control node, and is configured to control the potential of the second control node under the control of a signal provided by the node control terminal; the node control terminal is the first node in the adjacent upper m-stage driving circuit or the first control node in the adjacent upper m-stage driving circuit, where m is a positive integer, and
the second node control circuit is electrically connected to the second control node, the control clock signal terminal, and a second node respectively, and is configured to control the potential of the second node according to the control clock signal provided by the control clock signal terminal under the control of the second control node.

Optionally, the second control node control circuit is further electrically connected to a second voltage terminal or an adjacent upper-stage intermediate node, and is configured to control the connection between the second control node and the second voltage terminal or the adjacent upper-stage intermediate node under the control of the signal provided by the node control terminal.

Optionally, the second control node control circuit includes a first transistor.

The gate of the first transistor is electrically connected to the node control terminal, the first electrode of the first transistor is electrically connected to the second voltage terminal or the adjacent upper-stage intermediate node, and the second electrode of the first transistor is electrically connected to the second control node.

Optionally, the second control node control circuit includes a first control circuit, a second control circuit, and a third control circuit.

The first control circuit is electrically connected to the node control terminal, a third voltage terminal, and an intermediate node, and is configured to control the connection between the intermediate node and the third voltage terminal under the control of the signal provided by the node control terminal.

The second control circuit is electrically connected to the node control terminal, the intermediate node, and the second control node, and is configured to control the connection between the intermediate node and the second control node under the control of the signal provided by the node control terminal.

The third control circuit is electrically connected to the second control node, the intermediate node, and a fourth voltage terminal, and is configured to control the connection between the intermediate node and the fourth voltage terminal under the control of the second control node.

Optionally, the first control circuit includes a first transistor, the second control circuit includes a second transistor, and the third control circuit includes a third transistor.

The gate of the first transistor is electrically connected to the node control terminal, the first electrode of the first transistor is electrically connected to the third voltage terminal, and the second electrode of the first transistor is electrically connected to the intermediate node.

The gate of the second transistor is electrically connected to the node control terminal, the first electrode of the second transistor is electrically connected to the intermediate node, and the second electrode of the second transistor is electrically connected to the second control node.

The gate of the third transistor is electrically connected to the second control node, the first electrode of the third transistor is electrically connected to the fourth voltage terminal, and the second electrode of the third transistor is electrically connected to the intermediate node.

Optionally, the driving circuit according to at least one embodiment of the present disclosure further includes an output circuit and an output reset circuit.

The output circuit is electrically connected to the first node, a driving signal output terminal, and the first voltage terminal, and is configured to control the connection between the driving signal output terminal and the first voltage terminal under the control of the first node.

The output reset circuit is electrically connected to the second node, the driving signal output terminal, and the second voltage terminal, and is configured to control the connection between the driving signal output terminal and the second voltage terminal under the control of the second node.

Optionally, the driving circuit according to at least one embodiment of the present disclosure further includes a carry output circuit, a carry reset circuit, an output circuit, and an output reset circuit.

The carry output circuit is electrically connected to the first node, a carry signal output terminal, and the first voltage terminal, and is configured to control the connection between the carry signal output terminal and the first voltage terminal under the control of the first node.

The carry reset circuit is electrically connected to the second node, the carry signal output terminal, and the second voltage terminal, and is configured to control the connection between the carry signal output terminal and the second voltage terminal under the control of the second node.

The output circuit is electrically connected to the first node, a driving signal output terminal, and a fifth voltage terminal, and is configured to control the connection between the driving signal output terminal and the fifth voltage terminal under the control of the first node.

The output reset circuit is electrically connected to the second node, the driving signal output terminal, and a sixth voltage terminal, and is configured to control the connection between the driving signal output terminal and the sixth voltage terminal under the control of the second node.

Optionally, the second node control circuit is further electrically connected to the first control node, and is configured to control the potential of the second node under the control of the first control node.

The driving circuit further includes a control energy storage circuit.

The control energy storage circuit is electrically connected to the control clock signal terminal and the second control node, and is configured to control the potential of the second control node according to the control clock signal.

Optionally, the driving circuit according to at least one embodiment of the present disclosure further includes a first energy storage circuit and a second energy storage circuit.

A first terminal of the first energy storage circuit is electrically connected to the first node, a second terminal of the first energy storage circuit is electrically connected to the driving signal output terminal, and the first energy storage circuit is configured to store electrical energy.

The second energy storage circuit is electrically connected to the second node, and the second energy storage circuit is configured to maintain the potential of the second node.

Optionally, the driving circuit according to at least one embodiment of the present disclosure further includes a first energy storage circuit and a second energy storage circuit.

A first terminal of the first energy storage circuit is electrically connected to the first node, a second terminal of the first energy storage circuit is electrically connected to the carry signal output terminal, and the first energy storage circuit is configured to store electrical energy.

The second energy storage circuit is electrically connected to the second node, and the second energy storage circuit is configured to maintain the potential of the second node.

Optionally, the first control node control circuit includes a fourth transistor, and the first node control circuit includes a fifth transistor.

The gate of the fourth transistor is electrically connected to the control clock signal terminal, the first electrode of the fourth transistor is electrically connected to the input terminal, and the second electrode of the fourth transistor is electrically connected to the first control node.

The gate of the fifth transistor is electrically connected to the first voltage terminal, the first electrode of the fifth transistor is electrically connected to the first control node, and the second electrode of the fifth transistor is electrically connected to the first node.

Optionally, the second node control circuit includes a sixth transistor and a seventh transistor.

The gate of the sixth transistor is electrically connected to the second control node, the first electrode of the sixth transistor is electrically connected to the control clock signal terminal, and the second electrode of the sixth transistor is electrically connected to the second node.

The gate of the seventh transistor is electrically connected to the first control node, the first electrode of the seventh transistor is electrically connected to the second voltage terminal, and the second electrode of the seventh transistor is electrically connected to the second node.

Optionally, the output circuit includes an output transistor, and the output reset circuit includes an output reset transistor.

The gate of the output transistor is electrically connected to the first node, the first electrode of the output transistor is electrically connected to the first voltage terminal, and the second electrode of the output transistor is electrically connected to the driving signal output terminal.

The gate of the output reset transistor is electrically connected to the second node, the first electrode of the output reset transistor is electrically connected to the driving signal output terminal, and the second electrode of the output reset transistor is electrically connected to the second voltage terminal.

Optionally, the carry output circuit includes a carry output transistor, the carry reset circuit includes a carry reset transistor, the output circuit includes an output transistor, and the output reset circuit includes an output reset transistor.

The gate of the carry output transistor is electrically connected to the first node, the first electrode of the carry output transistor is electrically connected to the first voltage terminal, and the second electrode of the carry output transistor is electrically connected to the carry signal output terminal.

The gate of the carry reset transistor is electrically connected to the second node, the first electrode of the carry reset transistor is electrically connected to the carry signal output terminal, and the second electrode of the carry reset transistor is electrically connected to the second voltage terminal.

The gate of the output transistor is electrically connected to the first node, the first electrode of the output transistor is electrically connected to the fifth voltage terminal, and the second electrode of the output transistor is electrically connected to the driving signal output terminal.

The gate of the output reset transistor is electrically connected to the second node, the first electrode of the output reset transistor is electrically connected to the driving signal output terminal, and the second electrode of the output reset transistor is electrically connected to the sixth voltage terminal.

In a second aspect, an embodiment of the present disclosure provides a driving module, which includes multiple stages of the above-mentioned driving circuits.

Optionally, the node control terminal of the a-th stage driving circuit is the first node in the (a-m)-th stage driving circuit or the first control node in the (a-m)-th stage driving circuit.

Both a and m are positive integers.

Optionally, the second control node control circuit in the n-th stage driving circuit includes an n-th stage first control circuit, an n-th stage second control circuit, and an n-th stage third control circuit, where n is a positive integer.

The second control node control circuit in the (n+1)-th stage driving circuit is electrically connected to the (n+1)-th node control terminal, the (n+1)-th stage second control node, and the n-th stage intermediate node, and is configured to control the connection between the (n+1)-th stage second control node and the adjacent upper-stage intermediate node under the control of the signal provided by the (n+1)-th node control terminal.

The n-th stage first control circuit is electrically connected to the n-th node control terminal, the third voltage terminal, and the n-th stage intermediate node, and is configured to control the connection between the n-th stage intermediate node and the third voltage terminal under the control of the signal provided by the n-th node control terminal.

The n-th stage second control circuit is electrically connected to the n-th node control terminal, the n-th stage intermediate node, and the n-th stage second control node, and is configured to control the connection between the n-th stage intermediate node and the n-th stage second control node under the control of the signal provided by the n-th node control terminal.

The n-th stage third control circuit is electrically connected to the n-th stage second control node, the n-th stage intermediate node, and the fourth voltage terminal, and is configured to control the connection between the n-th stage intermediate node and the fourth voltage terminal under the control of the n-th stage second control node.

In a third aspect, an embodiment of the present disclosure provides a driving method applied to the above-mentioned driving circuit, the driving method including:
controlling, by the first control node control circuit, the connection between the first control node and the input terminal under the control of the control clock signal;
controlling, by the first node control circuit, the connection between the first control node and the first node under the control of the first voltage signal;
controlling, by the second control node control circuit, the potential of the second control node under the control of the potential of the first node in the adjacent upper m-stage driving circuit or the first control node in the adjacent upper m-stage driving circuit, where m is a positive integer; and
controlling, by the second node control circuit, the potential of the second node according to the control clock signal under the control of the second control node.

Optionally, the step in which the second control node control circuit controls the potential of the second control node under the control of the potential of the first node in the adjacent upper m-stage driving circuit or the first control node in the adjacent upper m-stage driving circuit includes:
controlling, by the second control node control circuit, the connection between the second control node and the second voltage terminal or the adjacent upper-stage intermediate node under the control of the potential of the first node in the adjacent upper m-stage driving circuit or the first control node in the adjacent upper m-stage driving circuit.

Optionally, the second control node control circuit includes a first control circuit, a second control circuit, and a third control circuit; the step of controlling, by the second control node control circuit, the potential of the second control node under the control of the potential of the first node in the adjacent upper m-stage driving circuit or the first control node in the adjacent upper m-stage driving circuit includes:
controlling, by the first control circuit, the connection between the intermediate node and the third voltage terminal under the control of the potential of the first node in the adjacent upper m-stage driving circuit or the first control node in the adjacent upper m-stage driving circuit;
controlling, by the second control circuit, the connection between the intermediate node and the second control node under the control of the potential of the first node in the adjacent upper m-stage driving circuit or the first control node in the adjacent upper m-stage driving circuit; and
controlling, by the third control circuit controls the connection between the intermediate node and the fourth voltage terminal under the control of the second control node.

Optionally, the driving circuit further includes an output circuit and an output reset circuit; the driving method further includes:
controlling, by the output circuit, the connection between the driving signal output terminal and the first voltage terminal under the control of the first node;
controlling, by the output reset circuit, the connection between the driving signal output terminal and the second voltage terminal under the control of the second node; and
controlling, by the second node control circuit, the potential of the second node under the control of the first node.

In a fourth aspect, at least one embodiment of the present disclosure provides a display device, which includes the above-mentioned driving module.

The driving circuit, the driving module, the driving method, and the display device according to the embodiments of the present disclosure enables complete reset of the second control node, thereby eliminating the potential distortion in the driving signal output from the driving circuit.

### BRIEF DESCRIPTION OF THE DRAWINGS

FIG. 1 is a structural diagram of a driving circuit according to at least one embodiment of the present disclosure;

FIG. 2 is a structural diagram of a driving circuit according to at least one embodiment of the present disclosure;

FIG. 3 is a structural diagram of a driving circuit according to at least one embodiment of the present disclosure;

FIG. 4 is a structural diagram of a driving circuit according to at least one embodiment of the present disclosure;

FIG. 5 is a structural diagram of a driving circuit according to at least one embodiment of the present disclosure;

FIG. 6 is a structural diagram of a driving circuit according to at least one embodiment of the present disclosure;

FIG. 7 is a structural diagram of a driving circuit according to at least one embodiment of the present disclosure;

FIG. 8 is a structural diagram of a driving circuit according to at least one embodiment of the present disclosure;

FIG. 9 is a structural diagram of a driving circuit according to at least one embodiment of the present disclosure;

FIG. 10 is a structural diagram of a driving circuit according to at least one embodiment of the present disclosure;

FIG. 11 is a structural diagram of a driving circuit according to at least one embodiment of the present disclosure;

FIG. 12 is a structural diagram of a driving circuit according to at least one embodiment of the present disclosure;

FIG. 13 is a structural diagram of a driving circuit according to at least one embodiment of the present disclosure;

FIG. 14 is a structural diagram of a driving circuit according to at least one embodiment of the present disclosure;

FIG. 15 is a structural diagram of a driving circuit according to at least one embodiment of the present disclosure;

FIG. 16 is a structural diagram of a driving circuit according to at least one embodiment of the present disclosure;

FIG. 17 is a circuit diagram of a driving circuit according to at least one embodiment of the present disclosure;

FIG. 18 is a timing sequence diagram of at least one embodiment of the driving circuit shown in FIG. 17;

FIG. 19 is a circuit diagram of the (n−1)-th stage driving circuit and the n-th stage driving circuit in a driving module according to at least one embodiment of the present disclosure;

FIG. 20 is a timing sequence diagram of at least one embodiment of the driving circuit shown in FIG. 19;

FIG. 21 is a circuit diagram of a driving circuit according to at least one embodiment of the present disclosure;

FIG. 22 is a circuit diagram of a driving circuit according to at least one embodiment of the present disclosure;

FIG. 23 is a timing sequence diagram of at least one embodiment of the driving circuit shown in FIG. 22;

FIG. 24 is a circuit diagram of the n-th stage driving circuit and the (n+1)-th stage driving circuit in a driving module according to at least one embodiment of the present disclosure;

FIG. 25 is a circuit diagram of a driving circuit according to at least one embodiment of the present disclosure;

FIG. 26 is a circuit diagram of a driving circuit according to at least one embodiment of the present disclosure;

FIG. 27 is a timing sequence diagram of at least one embodiment of the driving circuit shown in FIG. 26; and

FIG. 28 is a circuit diagram of a driving circuit according to at least one embodiment of the present disclosure.

### DETAILED DESCRIPTION

The technical solutions in the embodiments of the present disclosure will be clearly and completely described below with reference to the drawings accompanying the embodiments of the present disclosure. Obviously, the described embodiments are only a part of the embodiments of the present disclosure, rather than all of them. Based on the embodiments in the present disclosure, all other embodiments obtained by those of ordinary skill in the art without making creative efforts shall fall within the protection scope of the present disclosure.

The transistors used in all embodiments of the present disclosure may be thin-film transistors, field-effect transistors, or other devices with the same characteristics. In the embodiments of the present disclosure, to distinguish the two electrodes of a transistor other than the gate, one electrode is called the first electrode, and the other electrode is called the second electrode.

In actual operation, when the transistor is a thin-film transistor or a field-effect transistor, the first electrode may be the drain and the second electrode may be the source. Alternatively, the first electrode may be the source and the second electrode may be the drain.

A driving circuit according to an embodiment of the present disclosure includes a first control node control circuit, a first node control circuit, a second control node control circuit, and a second node control circuit.

The first control node control circuit is electrically connected to a control clock signal terminal, an input terminal, and a first control node, and is configured to control the connection between the first control node and the input terminal under the control of a control clock signal provided by the control clock signal terminal.

The first node control circuit is electrically connected to a first voltage terminal, the first control node, and a first node, and is configured to control the connection between the first control node and the first node under the control of a first voltage signal provided by the first voltage terminal.

The second control node control circuit is electrically connected to a node control terminal and a second control node, and is configured to control the potential of the second control node under the control of a signal provided by the node control terminal. The node control terminal is the first node in an adjacent upper m-stage driving circuit or the first control node in an adjacent upper m-stage driving circuit, where m is a positive integer.

The second node control circuit is electrically connected to the second control node, the control clock signal terminal, and a second node, and is configured to control the potential of the second node according to the control clock signal provided by the control clock signal terminal under the control of the second control node.

In at least one embodiment of the present disclosure, the second control node control circuit controls the potential of the second control node under the potential of the node control terminal, where the node control terminal is the first node in the adjacent upper m-stage driving circuit, or the first control node in the adjacent upper m-stage driving circuit. When the adjacent upper m-stage driving circuit outputs a driving signal, the potential of the first node in the adjacent upper m-stage driving circuit and the potential of the first control node in the adjacent upper m-stage driving circuit will be bootstrap-raised. The second control node control circuit can better control the reset of the potential of the second control node under the control of the potential of the first node in the adjacent upper m-stage driving circuit and the first control node in the adjacent upper m-stage driving circuit, so that the second control node can be reset more completely, eliminating the potential distortion in the driving signal output by the driving circuit.

Optionally, the first voltage terminal may be, but is not limited to, a high level terminal.

In at least one embodiment of the present disclosure, m may be, but is not limited to, equal to 1. In actual operation, m may also be an integer greater than 1.

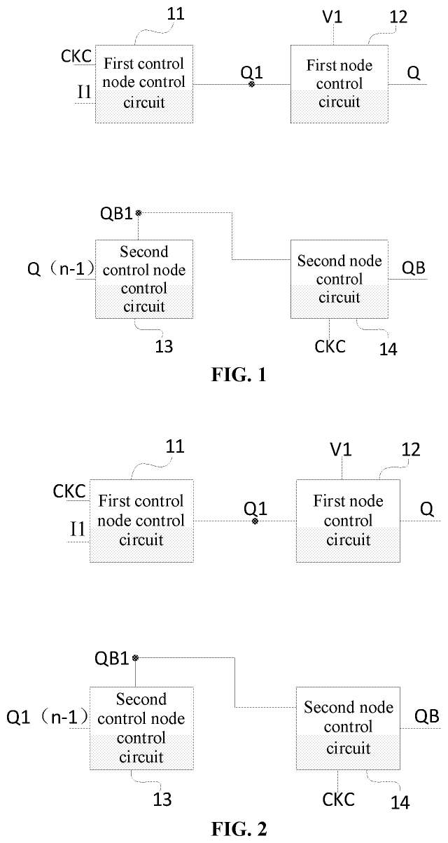

As shown in FIG. 1, a driving circuit according to an embodiment of the present disclosure includes a first control node control circuit 11, a first node control circuit 12, a second control node control circuit 13, and a second node control circuit 14.

The first control node control circuit 11 is electrically connected to a control clock signal terminal CKC, an input terminal I1, and a first control node Q1, and is configured to control the connection between the first control node Q1 and the input terminal I1 under the control of a control clock signal provided by the control clock signal terminal CKC.

The first node control circuit 12 is electrically connected to a first voltage terminal V1, the first control node Q1, and a first node Q, and is configured to control the connection between the first control node Q1 and the first node Q under the control of a first voltage signal provided by the first voltage terminal V1.

The second control node control circuit 13 is electrically connected to the first node Q(n−1) in the adjacent upper-stage driving circuit and a second control node QB1, and is configured to control the potential of the second control node QB1 under the control of the first node Q(n−1) in the adjacent upper-stage driving circuit.

The second node control circuit 14 is electrically connected to the second control node QB1, the control clock signal terminal CKC, and a second node QB, and is configured to control the potential of the second node QB according to the control clock signal provided by the control clock signal terminal CKC under the control of the second control node QB1.

As shown in FIG. 2, a driving circuit according to an embodiment of the present disclosure includes a first control node control circuit 11, a first node control circuit 12, a second control node control circuit 13, and a second node control circuit 14.

The first control node control circuit 11 is electrically connected to a control clock signal terminal CKC, an input terminal I1, and a first control node Q1, and is configured to control the connection between the first control node Q1 and the input terminal I1 under the control of a control clock signal provided by the control clock signal terminal CKC.

The first node control circuit 12 is electrically connected to a first voltage terminal V1, the first control node Q1, and a first node Q, and is configured to control the connection between the first control node Q1 and the first node Q under the control of a first voltage signal provided by the first voltage terminal V1.

The second control node control circuit 13 is electrically connected to the first control node Q1(n−1) in the adjacent upper-stage driving circuit and a second control node QB1, and is configured to control the potential of the second control node QB1 under the control of the first control node Q1(n−1) in the adjacent upper-stage driving circuit.

The second node control circuit 14 is electrically connected to the second control node QB1, the control clock signal terminal CKC, and a second node QB, and is configured to control the potential of the second node QB according to the control clock signal provided by the control clock signal terminal CKC under the control of the second control node QB1.

In at least one embodiment of the present disclosure, the second control node control circuit is further electrically connected to a second voltage terminal or an adjacent upper-stage intermediate node, and is configured to control the connection between the second control node and the second voltage terminal or the adjacent upper-stage intermediate node under the control of the signal provided by the node control terminal.

In specific implementation, the second control node control circuit may further control the electrical connection between the second control node and the second voltage terminal or the adjacent upper-stage intermediate node under the control of the signal provided by the node control terminal, so as to control the potential of the second control node.

Optionally, the second voltage terminal may be a low level terminal, but is not limited thereto.

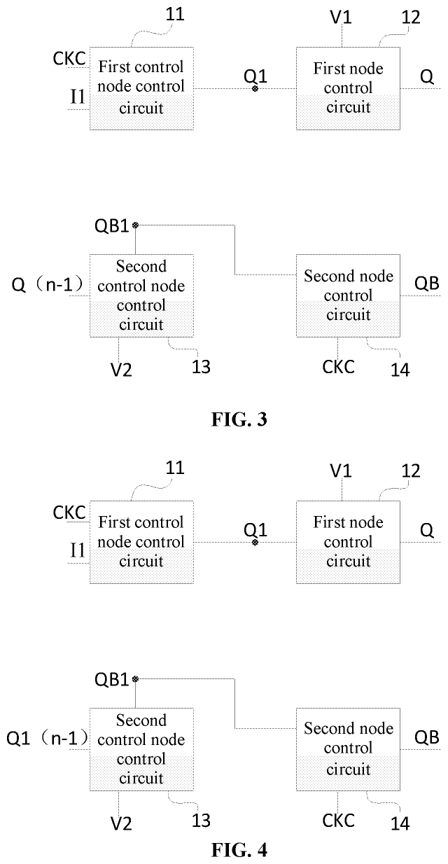

As shown in FIG. 3, based on at least one embodiment of the driving circuit shown in FIG. 1, the second control node control circuit 13 is further electrically connected to a second voltage terminal V2, and is configured to control the connection between the second control node and the second voltage terminal under the control of the first node Q(n−1) in the adjacent upper-stage driving circuit.

As shown in FIG. 4, based on at least one embodiment of the driving circuit shown in FIG. 2, the second control node control circuit 13 is further electrically connected to a second voltage terminal V2, and is configured to control the connection between the second control node and the second voltage terminal under the control of the first control node Q1(n−1) in the adjacent upper-stage driving circuit.

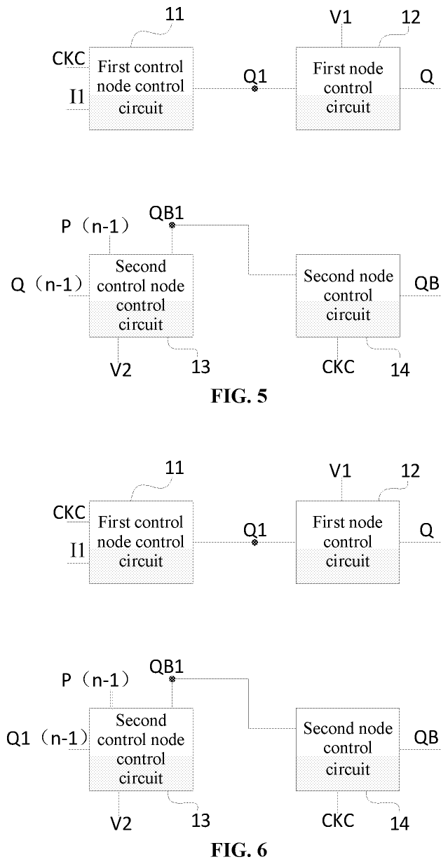

As shown in FIG. 5, based on at least one embodiment of the driving circuit shown in FIG. 1, the second control node control circuit 13 is further electrically connected to an adjacent upper-stage intermediate node P(n−1), and is configured to control the connection between the second control node and the adjacent upper-stage intermediate node P(n−1) under the control of the first node Q(n−1) in the adjacent upper-stage driving circuit.

As shown in FIG. 6, based on at least one embodiment of the driving circuit shown in FIG. 2, the second control node control circuit 13 is further electrically connected to an adjacent upper-stage intermediate node P(n−1), and is configured to control the connection between the second control node and the adjacent upper-stage intermediate node P(n−1) under the control of the first control node Q1(n−1) in the adjacent upper-stage driving circuit.

In at least one embodiment shown in FIGS. 1-6, the driving circuit is the n-th stage driving circuit, where n is a positive integer.

Optionally, the second control node control circuit includes a first transistor.

The gate of the first transistor is electrically connected to the node control terminal, a first electrode of the first transistor is electrically connected to the second voltage terminal or the adjacent upper-stage intermediate node, and a second electrode of the first transistor is electrically connected to the second control node.

In at least one embodiment of the present disclosure, the second control node control circuit includes a first control circuit, a second control circuit, and a third control circuit.

The first control circuit is electrically connected to the node control terminal, a third voltage terminal, and an intermediate node, and is configured to control the connection between the intermediate node and the third voltage terminal under the control of the signal provided by the node control terminal.

The second control circuit is electrically connected to the node control terminal, the intermediate node, and the second control node, and is configured to control the connection between the intermediate node and the second control node under the control of the signal provided by the node control terminal.

The third control circuit is electrically connected to the second control node, the intermediate node, and a fourth voltage terminal, and is configured to control the connection between the intermediate node and the fourth voltage terminal under the control of the second control node.

Optionally, the third voltage terminal may be a first low level terminal, and the fourth voltage terminal may be a first high level terminal or a second high level terminal.

In specific implementation, the second control node control circuit includes a first control circuit, a second control circuit, and a third control circuit. When the third control circuit controls the electrical connection between the intermediate node and the fourth voltage terminal under the control of the second control node, the fourth voltage terminal may be a first high level terminal or a second high level terminal, so that the potential of the second control node will not decrease in case of leakage.

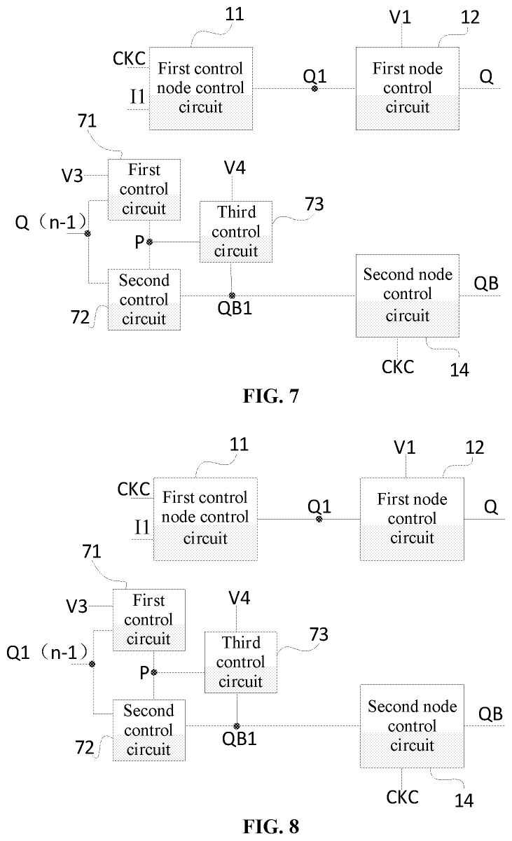

As shown in FIG. 7, based on at least one embodiment of the driving circuit shown in FIG. 1, the second control node control circuit includes a first control circuit 71, a second control circuit 72, and a third control circuit 73.

The first control circuit 71 is electrically connected to the first node Q(n−1) in the adjacent upper-stage driving circuit, a third voltage terminal V3, and an intermediate node P, and is configured to control the connection between the intermediate node P and the third voltage terminal V3 under the control of the first node Q(n−1) in the adjacent upper-stage driving circuit;

The second control circuit 72 is electrically connected to the first node Q(n−1) in the adjacent upper-stage driving circuit, the intermediate node P, and the second control node QB1, and is configured to control the connection between the intermediate node P and the second control node QB1 under the control of the first node Q(n−1) in the adjacent upper-stage driving circuit;

The third control circuit 73 is electrically connected to the second control node QB1, the intermediate node P, and a fourth voltage terminal V4, and is configured to control the connection between the intermediate node P and the fourth voltage terminal V4 under the control of the second control node QB1.

In at least one embodiment shown in FIG. 7, the driving circuit is the n-th stage driving circuit, and the intermediate node P is the n-th stage intermediate node P(n).

As shown in FIG. 8, based on at least one embodiment of the driving circuit shown in FIG. 2, the second control node control circuit includes a first control circuit 71, a second control circuit 72, and a third control circuit 73.

The first control circuit 71 is electrically connected to the first control node Q1(n−1) in the adjacent upper-stage driving circuit, a third voltage terminal, and an intermediate node P, and is configured to control the connection between the intermediate node P and the third voltage terminal V3 under the control of the first control node Q1(n−1) in the adjacent upper-stage driving circuit;

The second control circuit 72 is electrically connected to the first control node Q1(n−1) in the adjacent upper-stage driving circuit, the intermediate node P, and the second control node QB1, and is configured to control the connection between the intermediate node P and the second control node QB1 under the control of the first control node Q1(n−1) in the adjacent upper-stage driving circuit;

The third control circuit 73 is electrically connected to the second control node QB1, the intermediate node P, and a fourth voltage terminal V4, and is configured to control the connection between the intermediate node P and the fourth voltage terminal V4 under the control of the second control node QB1.

In at least one embodiment shown in FIG. 8, the driving circuit is the n-th stage driving circuit, and the intermediate node P is the n-th stage intermediate node P(n).

Optionally, the first control circuit includes a first transistor, the second control circuit includes a second transistor, and the third control circuit includes a third transistor.

The gate of the first transistor is electrically connected to the node control terminal, the first electrode of the first transistor is electrically connected to the third voltage terminal, and the second electrode of the first transistor is electrically connected to the intermediate node.

The gate of the second transistor is electrically connected to the node control terminal, the first electrode of the second transistor is electrically connected to the intermediate node, and the second electrode of the second transistor is electrically connected to the second control node.

The gate of the third transistor is electrically connected to the second control node, the first electrode of the third transistor is electrically connected to the fourth voltage terminal, and the second electrode of the third transistor is electrically connected to the intermediate node.

A driving circuit according to at least one embodiment of the present disclosure further includes an output circuit and an output reset circuit.

The output circuit is electrically connected to the first node, a driving signal output terminal, and the first voltage terminal, and is configured to control the connection between the driving signal output terminal and the first voltage terminal under the control of the first node.

The output reset circuit is electrically connected to the second node, the driving signal output terminal, and the second voltage terminal, and is configured to control the connection between the driving signal output terminal and the second voltage terminal under the control of the second node.

In specific implementation, the driving circuit may further include an output circuit and an output reset circuit. The output circuit controls the connection between the driving signal output terminal and the first voltage terminal under the control of the first node to output a driving signal. The output reset circuit controls the connection between the driving signal output terminal and the second voltage terminal under the control of the second node to reset the driving signal.

Optionally, the first voltage terminal may be a high level terminal, and the second voltage terminal may be a low level terminal, but are not limited thereto.

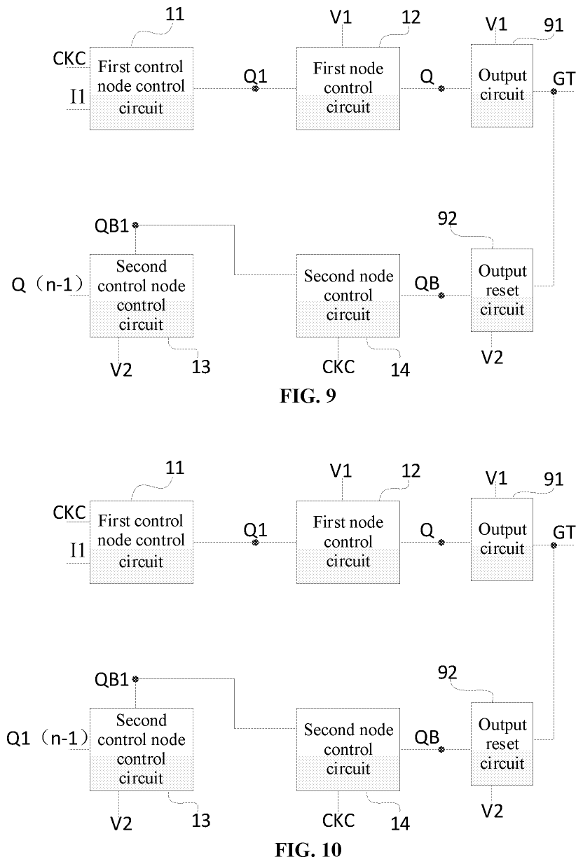

As shown in FIG. 9, based on at least one embodiment of the driving circuit shown in FIG. 3, the driving circuit according to at least one embodiment of the present disclosure further includes an output circuit 91 and an output reset circuit 92.

The output circuit 91 is electrically connected to the first node Q, a driving signal output terminal GT, and the first voltage terminal V1, and is configured to control the connection between the driving signal output terminal GT and the first voltage terminal V1 under the control of the first node Q.

The output reset circuit 92 is electrically connected to the second node QB, the driving signal output terminal GT, and the second voltage terminal V2, and is configured to control the connection between the driving signal output terminal GT and the second voltage terminal V2 under the control of the second node QB.

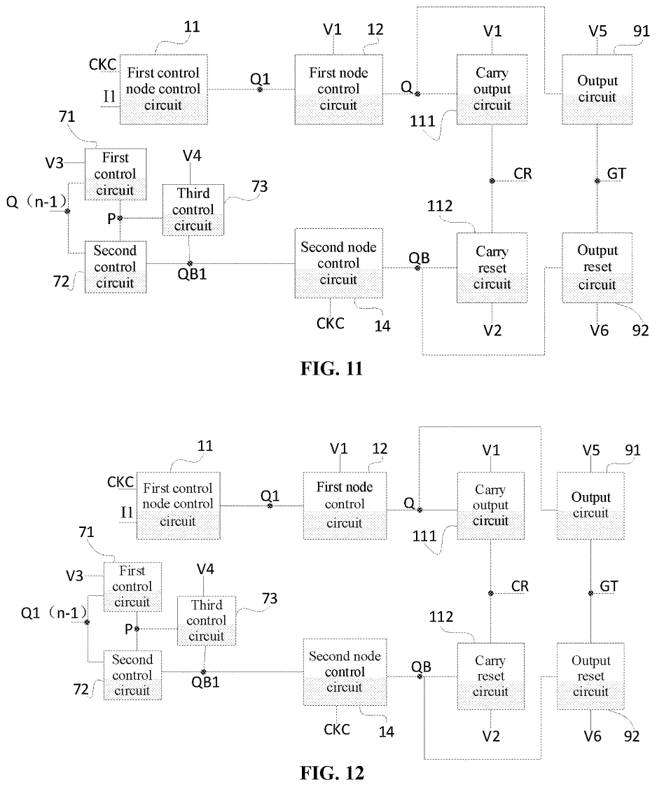

As shown in FIG. 10, based on at least one embodiment of the driving circuit shown in FIG. 4, the driving circuit according to at least one embodiment of the present disclosure further includes an output circuit 91 and an output reset circuit 92.

The output circuit 91 is electrically connected to the first node Q, a driving signal output terminal GT, and the first voltage terminal V1, and is configured to control the connection between the driving signal output terminal GT and the first voltage terminal V1 under the control of the first node Q.

The output reset circuit 92 is electrically connected to the second node QB, the driving signal output terminal GT, and the second voltage terminal V2, and is configured to control the connection between the driving signal output terminal GT and the second voltage terminal V2 under the control of the second node QB.

The driving circuit according to at least one embodiment of the present disclosure further includes a carry output circuit, a carry reset circuit, an output circuit, and an output reset circuit.

The carry output circuit is electrically connected to the first node, a carry signal output terminal, and the first voltage terminal, and is configured to control the connection between the carry signal output terminal and the first voltage terminal under the control of the first node.

The carry reset circuit is electrically connected to the second node, the carry signal output terminal, and the second voltage terminal, and is configured to control the connection between the carry signal output terminal and the second voltage terminal under the control of the second node.

The output circuit is electrically connected to the first node, a driving signal output terminal, and a fifth voltage terminal, and is configured to control the connection between the driving signal output terminal and the fifth voltage terminal under the control of the first node.

The output reset circuit is electrically connected to the second node, the driving signal output terminal, and a sixth voltage terminal, and is configured to control the connection between the driving signal output terminal and the sixth voltage terminal under the control of the second node.

Optionally, the first voltage terminal may be a first high level terminal, the second voltage terminal may be a first low level terminal, the fifth voltage terminal may be a second high level terminal, and the sixth voltage terminal may be a second low level terminal, but are not limited thereto.

As shown in FIG. 11, based on at least one embodiment of the driving circuit shown in FIG. 7, the driving circuit according to at least one embodiment of the present disclosure further includes a carry output circuit 111, a carry reset circuit 112, an output circuit 91, and an output reset circuit 92.

The carry output circuit 111 is electrically connected to the first node Q, a carry signal output terminal CR, and the first voltage terminal V1, and is configured to control the connection between the carry signal output terminal CR and the first voltage terminal V1 under the control of the first node Q.

The carry reset circuit 112 is electrically connected to the second node QB, the carry signal output terminal CR, and the second voltage terminal V2, and is configured to control the connection between the carry signal output terminal CR and the second voltage terminal V2 under the control of the second node QB.

The output circuit 91 is electrically connected to the first node Q, a driving signal output terminal GT, and a fifth voltage terminal V5, and is configured to control the connection between the driving signal output terminal GT and the fifth voltage terminal V5 under the control of the first node Q.

The output reset circuit 92 is electrically connected to the second node QB, the driving signal output terminal GT, and a sixth voltage terminal V6, and is configured to control the connection between the driving signal output terminal GT and the sixth voltage terminal V6 under the control of the second node QB.

As shown in FIG. 12, based on at least one embodiment of the driving circuit shown in FIG. 8, the driving circuit according to at least one embodiment of the present disclosure further includes a carry output circuit 111, a carry reset circuit 112, an output circuit 91, and an output reset circuit 92.

The carry output circuit 111 is electrically connected to the first node Q, a carry signal output terminal CR, and the first voltage terminal V1, and is configured to control the connection between the carry signal output terminal CR and the first voltage terminal V1 under the control of the first node Q.

The carry reset circuit 112 is electrically connected to the second node QB, the carry signal output terminal CR, and the second voltage terminal V2, and is configured to control the connection between the carry signal output terminal CR and the second voltage terminal V2 under the control of the second node QB.

The output circuit 91 is electrically connected to the first node Q, a driving signal output terminal GT, and a fifth voltage terminal V5, and is configured to control the connection between the driving signal output terminal GT and the fifth voltage terminal V5 under the control of the first node Q.

The output reset circuit 92 is electrically connected to the second node QB, the driving signal output terminal GT, and a sixth voltage terminal V6, and is configured to control the connection between the driving signal output terminal GT and the sixth voltage terminal V6 under the control of the second node QB.

In at least one embodiment of the present disclosure, the second node control circuit is further electrically connected to the first control node, and is configured to control the potential of the second node under the control of the first control node.

The driving circuit further includes a control energy storage circuit.

The control energy storage circuit is electrically connected to the control clock signal terminal and the second control node, and is configured to control the potential of the second control node according to the control clock signal.

In specific implementation, the second node control circuit controls the potential of the second node under the control of the first control node to reset the potential of the second node, and the control energy storage circuit controls the potential of the second control node according to the control clock signal.

The driving circuit according to at least one embodiment of the present disclosure further includes a first energy storage circuit and a second energy storage circuit.

A first terminal of the first energy storage circuit is electrically connected to the first node, a second terminal of the first energy storage circuit is electrically connected to the driving signal output terminal, and the first energy storage circuit is configured to store electrical energy.

The second energy storage circuit is electrically connected to the second node, and the second energy storage circuit is configured to maintain the potential of the second node.

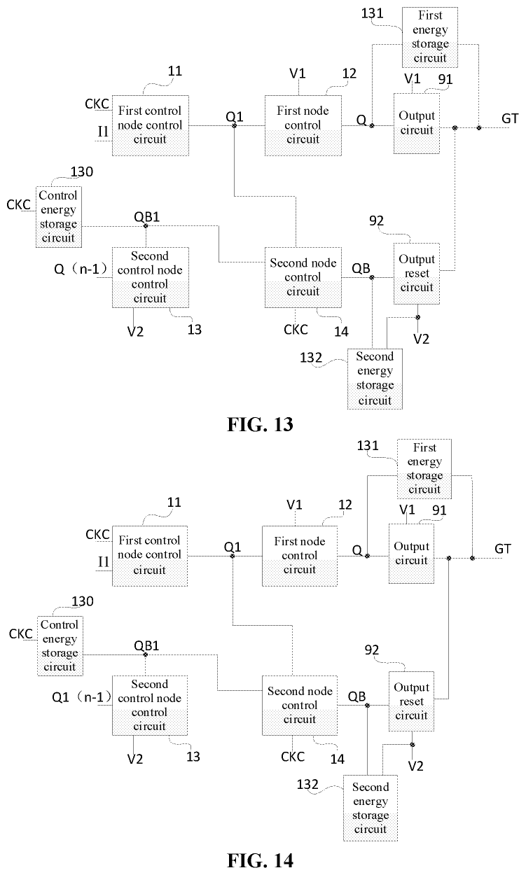

As shown in FIG. 13, based on at least one embodiment of the driving circuit shown in FIG. 9, the second node control circuit 14 is further electrically connected to the first control node Q1, and is configured to control the potential of the second node QB under the control of the first control node Q1.

The driving circuit according to at least one embodiment of the present disclosure may further include a control energy storage circuit 130, a first energy storage circuit 131, and a second energy storage circuit 132.

A first terminal of the control energy storage circuit 130 is electrically connected to the control clock signal terminal CKC, a second terminal of the control energy storage circuit 130 is electrically connected to the second control node QB1, and the control energy storage circuit 130 is configured to control the potential of the second control node QB1 according to the control clock signal provided by the control clock signal terminal CKC.

A first terminal of the first energy storage circuit 131 is electrically connected to the first node Q, a second terminal of the first energy storage circuit 131 is electrically connected to the driving signal output terminal GT, and the first energy storage circuit 131 is configured to store electrical energy.

A first terminal of the second energy storage circuit 132 is electrically connected to the second node QB, a second terminal of the second energy storage circuit 132 is electrically connected to the second voltage terminal V2, and the second energy storage circuit 132 is configured to maintain the potential of the second node QB.

As shown in FIG. 14, based on at least one embodiment of the driving circuit shown in FIG. 10, the second node control circuit 14 is further electrically connected to the first control node Q1, and is configured to control the potential of the second node QB under the control of the first control node Q1.

The driving circuit according to at least one embodiment of the present disclosure may further include a control energy storage circuit 130, a first energy storage circuit 131, and a second energy storage circuit 132.

A first terminal of the control energy storage circuit 130 is electrically connected to the control clock signal terminal CKC, a second terminal of the control energy storage circuit 130 is electrically connected to the second control node QB1, and the control energy storage circuit 130 is configured to control the potential of the second control node QB1 according to the control clock signal provided by the control clock signal terminal CKC.

A first terminal of the first energy storage circuit 131 is electrically connected to the first node Q, a second terminal of the first energy storage circuit 131 is electrically connected to the driving signal output terminal GT, and the first energy storage circuit 131 is configured to store electrical energy.

A first terminal of the second energy storage circuit 132 is electrically connected to the second node QB, a second terminal of the second energy storage circuit 132 is electrically connected to the second voltage terminal V2, and the second energy storage circuit 132 is configured to maintain the potential of the second node QB.

The driving circuit according to at least one embodiment of the present disclosure further includes a first energy storage circuit and a second energy storage circuit.

A first terminal of the first energy storage circuit is electrically connected to the first node, a second terminal of the first energy storage circuit is electrically connected to the carry signal output terminal, and the first energy storage circuit is configured to store electrical energy.

The second energy storage circuit is electrically connected to the second node, and the second energy storage circuit is configured to maintain the potential of the second node.

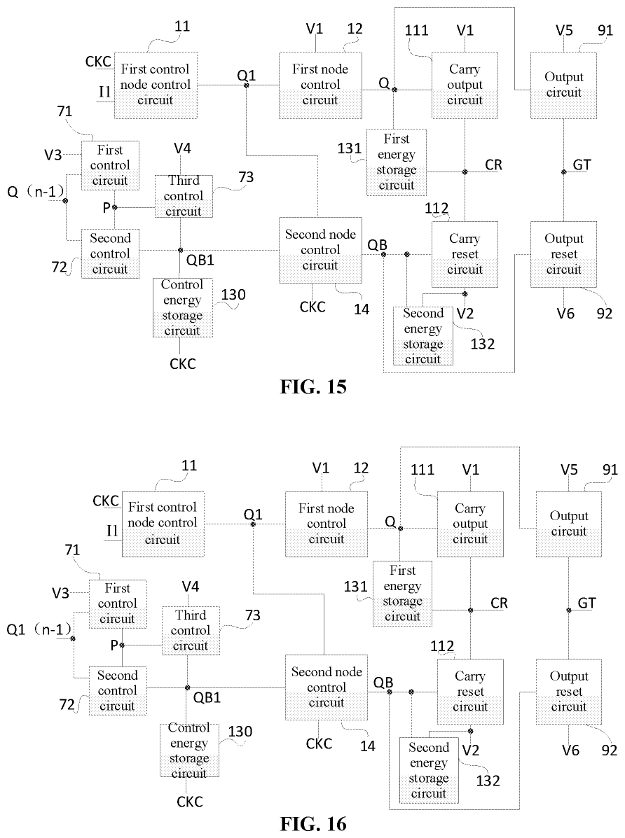

As shown in FIG. 15, based on at least one embodiment of the driving circuit shown in FIG. 11, the second node control circuit 14 is further electrically connected to the first control node Q1, and is configured to control the potential of the second node QB under the control of the first control node Q1.

The driving circuit according to at least one embodiment of the present disclosure may further include a control energy storage circuit 130, a first energy storage circuit 131, and a second energy storage circuit 132.

A first terminal of the control energy storage circuit 130 is electrically connected to the control clock signal terminal CKC, a second terminal of the control energy storage circuit 130 is electrically connected to the second control node QB1, and the control energy storage circuit 130 is configured to control the potential of the second control node QB1 according to the control clock signal provided by the control clock signal terminal CKC.

A first terminal of the first energy storage circuit 131 is electrically connected to the first node Q, a second terminal of the first energy storage circuit 131 is electrically connected to the carry signal output terminal CR, and the first energy storage circuit 131 is configured to store electrical energy.

A first terminal of the second energy storage circuit 132 is electrically connected to the second node QB, a second terminal of the second energy storage circuit 132 is electrically connected to the second voltage terminal V2, and the second energy storage circuit 132 is configured to maintain the potential of the second node QB.

As shown in FIG. 16, based on at least one embodiment of the driving circuit shown in FIG. 12, the second node control circuit 14 is further electrically connected to the first control node Q1, and is configured to control the potential of the second node QB under the control of the first control node Q1.

The driving circuit according to at least one embodiment of the present disclosure may further include a control energy storage circuit 130, a first energy storage circuit 131, and a second energy storage circuit 132.

A first terminal of the control energy storage circuit 130 is electrically connected to the control clock signal terminal CKC, a second terminal of the control energy storage circuit 130 is electrically connected to the second control node QB1, and the control energy storage circuit 130 is configured to control the potential of the second control node QB1 according to the control clock signal provided by the control clock signal terminal CKC.

A first terminal of the first energy storage circuit 131 is electrically connected to the first node Q, a second terminal of the first energy storage circuit 131 is electrically connected to the carry signal output terminal CR, and the first energy storage circuit 131 is configured to store electrical energy.

A first terminal of the second energy storage circuit 132 is electrically connected to the second node QB, a second terminal of the second energy storage circuit 132 is electrically connected to the second voltage terminal V2, and the second energy storage circuit 132 is configured to maintain the potential of the second node QB.

Optionally, the first control node control circuit includes a fourth transistor, and the first node control circuit includes a fifth transistor.

The gate of the fourth transistor is electrically connected to the control clock signal terminal, the first electrode of the fourth transistor is electrically connected to the input terminal, and the second electrode of the fourth transistor is electrically connected to the first control node.

The gate of the fifth transistor is electrically connected to the first voltage terminal, the first electrode of the fifth transistor is electrically connected to the first control node, and the second electrode of the fifth transistor is electrically connected to the first node.

Optionally, the second node control circuit includes a sixth transistor and a seventh transistor.

The gate of the sixth transistor is electrically connected to the second control node, the first electrode of the sixth transistor is electrically connected to the control clock signal terminal, and the second electrode of the sixth transistor is electrically connected to the second node.

The gate of the seventh transistor is electrically connected to the first control node, the first electrode of the seventh transistor is electrically connected to the second voltage terminal, and the second electrode of the seventh transistor is electrically connected to the second node.

Optionally, the output circuit includes an output transistor, and the output reset circuit includes an output reset transistor.

The gate of the output transistor is electrically connected to the first node, the first electrode of the output transistor is electrically connected to the first voltage terminal, and the second electrode of the output transistor is electrically connected to the driving signal output terminal.

The gate of the output reset transistor is electrically connected to the second node, the first electrode of the output reset transistor is electrically connected to the driving signal output terminal, and the second electrode of the output reset transistor is electrically connected to the second voltage terminal.

Optionally, the carry output circuit includes a carry output transistor, the carry reset circuit includes a carry reset transistor, the output circuit includes an output transistor, and the output reset circuit includes an output reset transistor.

The gate of the carry output transistor is electrically connected to the first node, the first electrode of the carry output transistor is electrically connected to the first voltage terminal, and the second electrode of the carry output transistor is electrically connected to the carry signal output terminal.

The gate of the carry reset transistor is electrically connected to the second node, the first electrode of the carry reset transistor is electrically connected to the carry signal output terminal, and the second electrode of the carry reset transistor is electrically connected to the second voltage terminal.

The gate of the output transistor is electrically connected to the first node, the first electrode of the output transistor is electrically connected to the fifth voltage terminal, and the second electrode of the output transistor is electrically connected to the driving signal output terminal.

The gate of the output reset transistor is electrically connected to the second node, the first electrode of the output reset transistor is electrically connected to the driving signal output terminal, and the second electrode of the output reset transistor is electrically connected to the sixth voltage terminal.

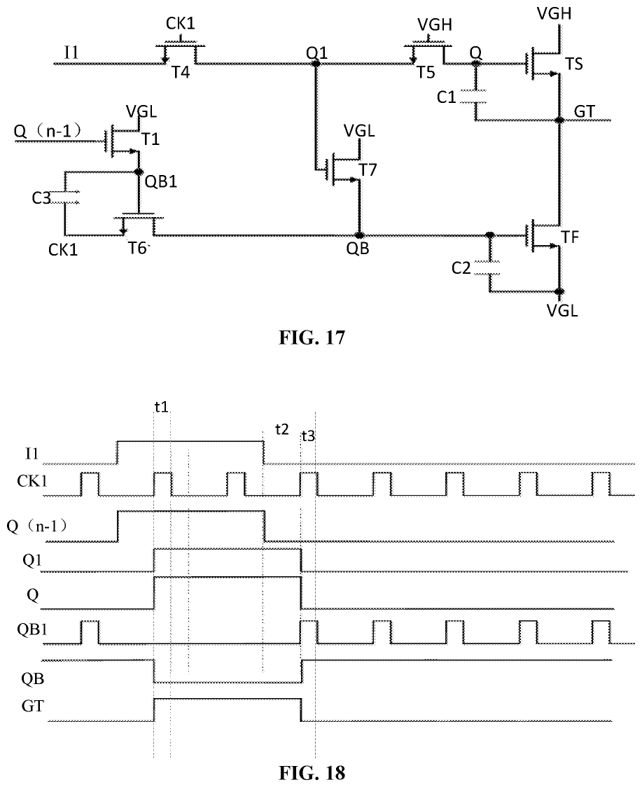

As shown in FIG. 17, based on at least one embodiment of the driving circuit shown in FIG. 13:
the second control node control circuit includes a first transistor T1;
the gate of the first transistor T1 is electrically connected to the first node Q(n−1) in an adjacent upper-stage driving circuit, the drain of the first transistor T1 is electrically connected to a low level terminal VGL, and the source of the first transistor T1 is electrically connected to the second control node QB1;
the first control node control circuit includes a fourth transistor T4, and the first node control circuit includes a fifth transistor T5;
the gate of the fourth transistor T4 is electrically connected to a first clock signal terminal CK1, the drain of the fourth transistor T4 is electrically connected to the input terminal I1, and the source of the fourth transistor T4 is electrically connected to the first control node Q1;
the gate of the fifth transistor T5 is electrically connected to a high level terminal VGH, the drain of the fifth transistor T5 is electrically connected to the first control node Q1, and the source of the fifth transistor T5 is electrically connected to the first node Q;
the second node control circuit includes a sixth transistor T6 and a seventh transistor T7;
the gate of the sixth transistor T6 is electrically connected to the second control node QB1, the drain of the sixth transistor T6 is electrically connected to the first clock signal terminal CK1, and the source of the sixth transistor T6 is electrically connected to the second node QB;
the gate of the seventh transistor T7 is electrically connected to the first control node Q1, the drain of the seventh transistor T7 is electrically connected to the low level terminal VGL, and the source of the seventh transistor T7 is electrically connected to the second node QB;
the output circuit includes an output transistor TS, and the output reset circuit includes an output reset transistor TF;
the gate of the output transistor TS is electrically connected to the first node Q, the drain of the output transistor TS is electrically connected to the high level terminal VGH, and the source of the output transistor TS is electrically connected to the driving signal output terminal GT;
the gate of the output reset transistor TF is electrically connected to the second node QB, the drain of the output reset transistor TF is electrically connected to the driving signal output terminal GT, and the source of the output reset transistor TF is electrically connected to the low level terminal VGL;
the first energy storage circuit includes a first capacitor C1, the second energy storage circuit includes a second capacitor C2, and the control energy storage circuit includes a third capacitor C3;
a first terminal of the first capacitor C1 is electrically connected to the first node Q, and a second terminal of the first capacitor C1 is electrically connected to the driving signal output terminal GT;
a first terminal of the second capacitor C2 is electrically connected to the second node QB, and a second terminal of the second capacitor C2 is electrically connected to the low level terminal VGL; and
a first terminal of the third capacitor C3 is electrically connected to the first clock signal terminal CK1, and a second terminal of the third capacitor C3 is electrically connected to the second control node QB.

In at least one embodiment of the driving circuit shown in FIG. 17, the control clock signal terminal is the first clock signal terminal, the first voltage terminal is the high level terminal, and the second voltage terminal is the low level terminal.

In at least one embodiment of the driving circuit shown in FIG. 17, all transistors are N-type transistors and oxide transistors, but are not limited thereto.

As shown in FIG. 18, when at least one embodiment of the driving circuit shown in FIG. 17 is at work, a display cycle may include a first stage t1, a second stage t2, and a third stage t3 in the same order.

In the first stage t1, I1 provides a high level signal, CK1 provides a high level signal, T4 is on, the potentials of Q1 and Q are high levels. At this time, the potential of Q(n−1) is higher than the potential of the input signal provided by I1, so T1 can be fully conductive. The potential of QB1 is a low level, T7 is on. The potential of QB is a low level, TS is on. GT provides a high level signal.

In the second stage t2, I1 provides a low level signal, CK1 provides a low level signal, both T4 and T6 are off, the potential of Q is maintained at a high level, the potential of QB is maintained at a low level, and GT outputs a high level signal.

In the third stage t3, CK1 provides a high level signal, I1 provides a low level signal, and T4 is on. The potential of Q1 is a low level, the potential of Q is a low level, the potential of QB1 is coupled to a high level by C3 to control T6 to be conductive, the potential of QB is a high level, TS is off, TF is on, and GT provides a low level signal.

In at least one embodiment of the driving circuit shown in FIG. 17, the gate of T1 is electrically connected to Q(n−1), and the potential of Q(n−1) will be bootstrap-raised when the adjacent upper-stage driving circuit outputs a driving signal. The potential of Q(n−1) is higher than the potential of the driving signal output by the adjacent upper-stage driving circuit. For example, the potential of Q(n−1) can reach 22V, and the potential of the driving signal output by the adjacent upper-stage driving circuit can reach 15V. In this way, T1 can reset the potential of QB1 more completely, eliminating the potential distortion in the driving signal output by GT.

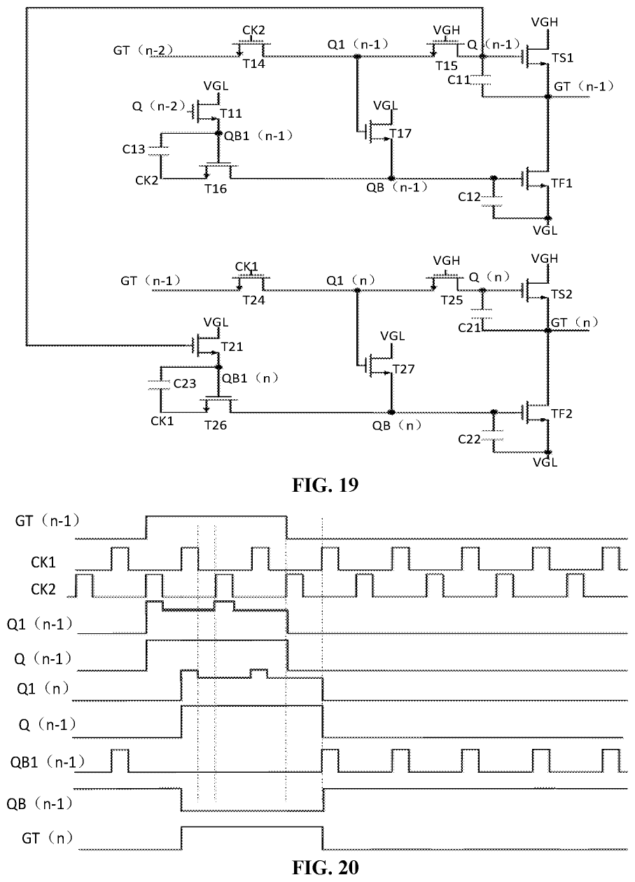

As shown in FIG. 19, the (n−1)-th stage driving circuit includes a first first transistor T11, a first fourth transistor T14, a first fifth transistor T15, a first sixth transistor T16, a first seventh transistor T17, a first output transistor TS1, a first output reset transistor TF1, a first first capacitor C11, a first second capacitor C12, and a first third capacitor C13.

The gate of the first first transistor T11 is electrically connected to the (n−2)-th stage first node Q(n−2), the drain of the first first transistor T11 is electrically connected to a low level terminal VGL, and the source of the first first transistor T11 is electrically connected to the (n−1)-th stage second control node QB1(n−1).

The gate of the first fourth transistor T14 is electrically connected to a second clock signal terminal CK2, the drain of the first fourth transistor T14 is electrically connected to the (n−2)-th stage driving signal output terminal GT(n−2), and the source of the first fourth transistor T14 is electrically connected to the (n−1)-th stage first control node Q1(n−1).

The gate of the first fifth transistor T15 is electrically connected to a high level terminal VGH, the drain of the first fifth transistor T15 is electrically connected to the (n−1)-th stage first control node Q1(n−1), and the source of the first fifth transistor T15 is electrically connected to the (n−1)-th stage first node Q(n−1).

The gate of the first sixth transistor T16 is electrically connected to the (n−1)-th stage second control node QB1(n−1), the drain of the first sixth transistor T16 is electrically connected to the second clock signal terminal CK2, and the source of the first sixth transistor T16 is electrically connected to the (n−1)-th stage second node QB(n−1).

The gate of the first seventh transistor T17 is electrically connected to the (n−1)-th stage first control node Q1(n−1), the drain of the first seventh transistor T17 is electrically connected to the low level terminal VGL, and the source of the first seventh transistor T17 is electrically connected to the (n−1)-th stage second node QB(n−1).

The gate of the first output transistor TS1 is electrically connected to the (n−1)-th stage first node Q(n−1), the drain of the first output transistor TS1 is electrically connected to the high level terminal VGH, and the source of the first output transistor TS1 is electrically connected to the (n−1)-th stage driving signal output terminal GT(n−1).

The gate of the first output reset transistor TF1 is electrically connected to the (n−1)-th stage second node QB(n−1), the drain of the first output reset transistor TF1 is electrically connected to the (n−1)-th stage driving signal output terminal GT(n−1), and the source of the first output reset transistor TF1 is electrically connected to the low level terminal VGL.

A first terminal of the first first capacitor C11 is electrically connected to the (n−1)-th stage first node Q(n−1), and a second terminal of the first first capacitor C11 is electrically connected to the (n−1)-th stage driving signal output terminal GT(n−1).

A first terminal of the first second capacitor C12 is electrically connected to the (n−1)-th stage second node QB(n−1), and a second terminal of the first second capacitor C12 is electrically connected to the low level terminal VGL.

A first terminal of the first third capacitor C13 is electrically connected to the second clock signal terminal CK2, and a second terminal of the first third capacitor C13 is electrically connected to the (n−1)-th stage second control node QB(n−1).

The n-th stage driving circuit includes a second first transistor T21, a second fourth transistor T24, a second fifth transistor T25, a second sixth transistor T26, a second seventh transistor T27, a second output transistor TS2, a second output reset transistor TF2, a second first capacitor C21, a second second capacitor C22, and a second third capacitor C23.

The gate of the second first transistor T21 is electrically connected to the (n−1)-th stage first node Q(n−1), the drain of the second first transistor T21 is electrically connected to the low level terminal VGL, and the source of the second first transistor T21 is electrically connected to the n-th stage second control node QB1(n).

The gate of the second fourth transistor T24 is electrically connected to a first clock signal terminal CK1, the drain of the second fourth transistor T24 is electrically connected to the (n−1)-th stage driving signal output terminal GT(n−1), and the source of the second fourth transistor T24 is electrically connected to the n-th stage first control node Q1(n).

The gate of the second fifth transistor T25 is electrically connected to the high level terminal VGH, the drain of the second fifth transistor T25 is electrically connected to the n-th stage first control node Q1(n), and the source of the second fifth transistor T25 is electrically connected to the n-th stage first node Q(n).

The gate of the second sixth transistor T26 is electrically connected to the n-th stage second control node QB1(n), the drain of the second sixth transistor T26 is electrically connected to the first clock signal terminal CK1, and the source of the second sixth transistor T26 is electrically connected to the n-th stage second node QB(n).

The gate of the second seventh transistor T27 is electrically connected to the n-th stage first control node Q1(n), the drain of the second seventh transistor T27 is electrically connected to the low level terminal VGL, and the source of the second seventh transistor T27 is electrically connected to the n-th stage second node QB(n).

The gate of the second output transistor TS2 is electrically connected to the n-th stage first node Q(n), the drain of the second output transistor TS2 is electrically connected to the high level terminal VGH, and the source of the second output transistor TS2 is electrically connected to the n-th stage driving signal output terminal GT(n).

The gate of the second output reset transistor TF2 is electrically connected to the n-th stage second node QB(n), the drain of the second output reset transistor TF2 is electrically connected to the n-th stage driving signal output terminal GT(n), and the source of the second output reset transistor TF is electrically connected to the low level terminal VGL.

A first terminal of the second first capacitor C21 is electrically connected to the n-th stage first node Q(n), and a second terminal of the second first capacitor C21 is electrically connected to the n-th stage driving signal output terminal GT(n).

A first terminal of the second second capacitor C22 is electrically connected to the n-th stage second node QB(n), and a second terminal of the second second capacitor C22 is electrically connected to the low level terminal VGL.

A first terminal of the second third capacitor C23 is electrically connected to the first clock signal terminal CK1, and a second terminal of the second third capacitor C23 is electrically connected to the n-th stage second control node QB(n).

The “n” is a positive integer.

In at least one embodiment of the driving circuit shown in FIG. 19, in the (n−1)-th stage driving circuit, the control clock signal terminal is the second clock signal terminal, and in the n-th stage driving circuit, the control clock signal terminal is the first clock signal terminal.

In at least one embodiment of the driving circuit shown in FIG. 19, all transistors are N-type transistors and oxide transistors, but are not limited thereto.

FIG. 20 is a timing sequence diagram of at least one embodiment of the driving circuit shown in FIG. 19.

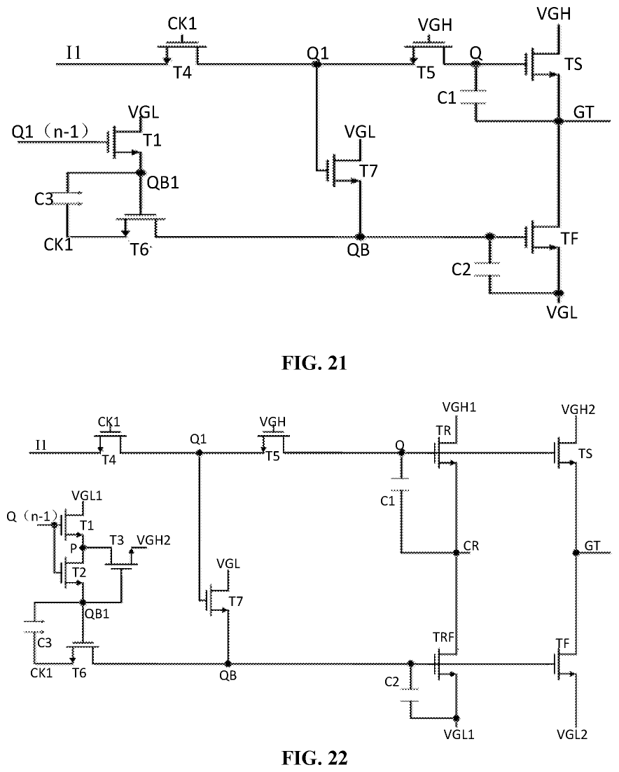

The difference between at least one embodiment of the driving circuit shown in FIG. 21 and at least one embodiment of the driving circuit shown in FIG. 17 lies in that:
the gate of the first transistor T1 is electrically connected to the first control node Q1(n−1) in the adjacent upper-stage driving circuit.

When at least one embodiment of the driving circuit shown in FIG. 21 is at work, when the potential of Q1 is at high level, the potential of Q1 can reach 22V when CK1 provides a high level signal, and the potential of Q1 can reach 15V when CK1 provides a low level signal, so as to reduce the PBTS (Positive Bias Temperature Stabilization) of T1.

As shown in FIG. 22, based on at least one embodiment of the driving circuit shown in FIG. 15, the first control circuit includes a first transistor T1, the second control circuit includes a second transistor T2, and the third control circuit includes a third transistor T3.

The gate of the first transistor T1 is connected to the first node Q(n−1) in the adjacent upper-stage driving circuit, the drain of the first transistor T1 is electrically connected to a first low level terminal VGL1, and the source of the first transistor T1 is electrically connected to an intermediate node P.

The gate of the second transistor T2 is electrically connected to the first node Q(n−1) in the adjacent upper-stage driving circuit, the drain of the second transistor T2 is electrically connected to the intermediate node P, and the source of the second transistor T2 is electrically connected to the second control node QB1.

The gate of the third transistor T3 is electrically connected to the second control node QB1, the drain of the third transistor T3 is electrically connected to a second high level terminal VGH2, and the source of the third transistor T3 is electrically connected to the intermediate node P.

The first control node control circuit includes a fourth transistor T4, and the first node control circuit includes a fifth transistor T5.

The gate of the fourth transistor T4 is electrically connected to a first clock signal terminal CK1, the drain of the fourth transistor T4 is electrically connected to the input terminal I1, and the source of the fourth transistor T4 is electrically connected to the first control node Q1.

The gate of the fifth transistor T5 is electrically connected to a high level terminal VGH, the drain of the fifth transistor T5 is electrically connected to the first control node Q1, and the source of the fifth transistor T5 is electrically connected to the first node Q.

The second node control circuit includes a sixth transistor T6 and a seventh transistor T7.

The gate of the sixth transistor T6 is electrically connected to the second control node QB1, the drain of the sixth transistor T6 is electrically connected to the first clock signal terminal CK1, and the source of the sixth transistor T6 is electrically connected to the second node QB.

The gate of the seventh transistor T7 is electrically connected to the first control node Q1, the drain of the seventh transistor T7 is electrically connected to a low level terminal VGL, and the source of the seventh transistor T7 is electrically connected to the second node QB.

The carry output circuit includes a carry output transistor TR, the carry reset circuit includes a carry reset transistor TRF, the output circuit includes an output transistor TS, and the output reset circuit includes an output reset transistor TF.

The gate of the carry output transistor TR is electrically connected to the first node Q, the drain of the carry output transistor TR is electrically connected to a first high level terminal VGH1, and the source of the carry output transistor TR is electrically connected to the carry signal output terminal CR.

The gate of the carry reset transistor TRF is electrically connected to the second node QB, the drain of the carry reset transistor TRF is electrically connected to the carry signal output terminal CR, and the source of the carry reset transistor TRF is electrically connected to the first low level terminal VGL1.

The gate of the output transistor TS is electrically connected to the first node Q, the drain of the output transistor TS is electrically connected to the second high level terminal VGH2, and the source of the output transistor TS is electrically connected to the driving signal output terminal GT.

The gate of the output reset transistor TF is electrically connected to the second node QB, the drain of the output reset transistor TF is electrically connected to the driving signal output terminal GT, and the source of the output reset transistor TF is electrically connected to a second low level terminal VGL2.

The control energy storage circuit includes a third capacitor C3, the first energy storage circuit includes a first capacitor C1, and the second energy storage circuit includes a second capacitor C2.

A first terminal of the third capacitor C3 is electrically connected to the first clock signal terminal CK1, and a second terminal of the third capacitor C3 is electrically connected to the second control node QB1.

A first terminal of the first capacitor C1 is electrically connected to the first node Q, and a second terminal of the first capacitor C1 is electrically connected to the carry signal output terminal CR.

A first terminal of the second capacitor C2 is electrically connected to the second node QB, and a second terminal of the second capacitor C2 is electrically connected to the first low level terminal VGL1.

In at least one embodiment of the driving circuit shown in FIG. 22, all transistors are N-type transistors and oxide transistors, but are not limited thereto.

In at least one embodiment of the driving circuit shown in FIG. 22, I1 is electrically connected to the carry signal output terminal in the adjacent upper-stage driving circuit.

When at least one embodiment of the driving circuit shown in FIG. 22 is at work, when the potential of QB1 is a high level, T3 is on, VGH2 is connected to P, and the potential of P is a high level, which can improve the problem of potential drop at QB1 caused by leakage.

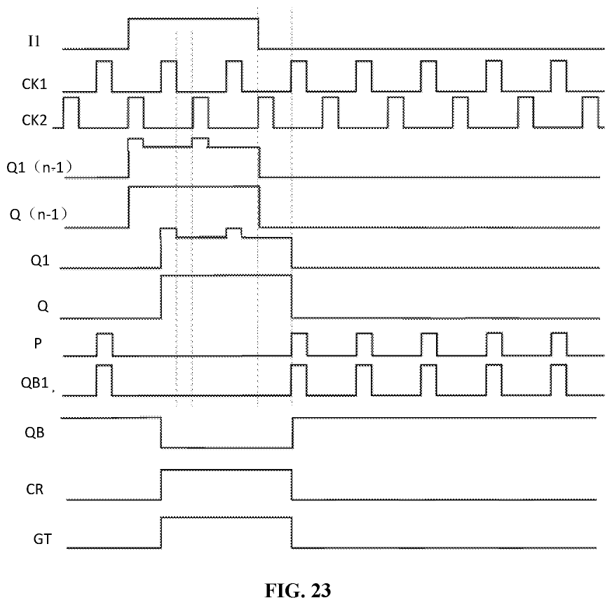

FIG. 23 is a timing sequence diagram of at least one embodiment of the driving circuit shown in FIG. 22.

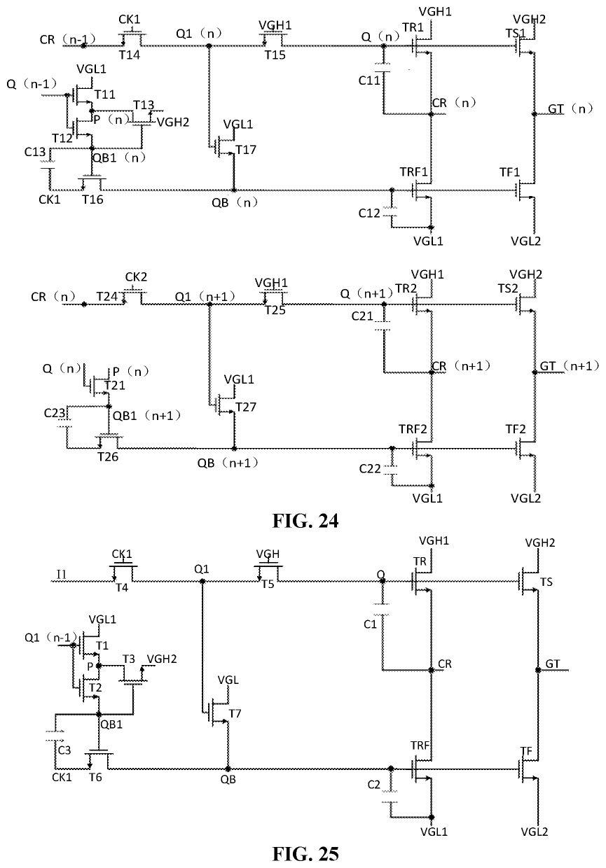

As shown in FIG. 24, the n-th stage driving circuit includes a first first transistor T11, a first second transistor T12, a first third transistor T13, a first fourth transistor T14, a first fifth transistor T15, a first sixth transistor T16, a first seventh transistor T17, a first carry output transistor TR1, a first carry reset transistor TRF1, a first output transistor TS1, a first output reset transistor TF1, a first first capacitor C11, a first second capacitor C12, and a first third capacitor C13.

The gate of the first first transistor T11 is connected to the n-th stage first node Q(n−1), the drain of the first first transistor T11 is electrically connected to the first low level terminal VGL1, and the source of the first first transistor T11 is electrically connected to the n-th stage intermediate node P(n).

The gate of the first second transistor T12 is electrically connected to the n-th stage first node Q(n−1), the drain of the first second transistor T12 is electrically connected to the n-th stage intermediate node P(n), and the source of the first second transistor T12 is electrically connected to the n-th stage second control node QB1(n).

The gate of the first third transistor T13 is electrically connected to the n-th stage second control node QB1(n), the drain of the first third transistor T13 is electrically connected to the second high level terminal VGH2, and the source of the first third transistor T13 is electrically connected to the n-th stage intermediate node P(n).

The gate of the first fourth transistor T14 is electrically connected to a first clock signal terminal CK1, the drain of the first fourth transistor T14 is electrically connected to the (n−1)-th stage carry signal output terminal CR(n−1), and the source of the first fourth transistor T14 is electrically connected to the n-th stage first control node Q1(n).

The gate of the first fifth transistor T15 is electrically connected to the first high level terminal VGH1, the drain of the first fifth transistor T15 is electrically connected to the n-th stage first control node Q1(n), and the source of the first fifth transistor T15 is electrically connected to the n-th stage first node Q(n).

The gate of the first sixth transistor T16 is electrically connected to the n-th stage second control node QB1(n), the drain of the first sixth transistor T16 is electrically connected to the first clock signal terminal CK1, and the source of the first sixth transistor T16 is electrically connected to the n-th stage second node QB(n).

The gate of the first seventh transistor T17 is electrically connected to the n-th stage first control node Q1(n), the drain of the first seventh transistor T17 is electrically connected to the first low level terminal VGL1, and the source of the first seventh transistor T17 is electrically connected to the n-th stage second node QB(n).

The gate of the first carry output transistor TR1 is electrically connected to the n-th stage first node Q(n), the drain of the first carry output transistor TR1 is electrically connected to the first high level terminal VGH1, and the source of the first carry output transistor TR1 is electrically connected to the n-th stage carry signal output terminal CR(n).

The gate of the first carry reset transistor TRF1 is electrically connected to the n-th stage second node QB(n), the drain of the first carry reset transistor TRF1 is electrically connected to the n-th stage carry signal output terminal CR(n), and the source of the first carry reset transistor TRF1 is electrically connected to the first low level terminal VGL1.

The gate of the first output transistor TS1 is electrically connected to the n-th stage first node Q(n), the drain of the first output transistor TS1 is electrically connected to the first high level terminal VGH1, and the source of the first output transistor TS1 is electrically connected to the n-th stage driving signal output terminal GT(n).

The gate of the first output reset transistor TF1 is electrically connected to the n-th stage second node QB(n), the drain of the first output reset transistor TF1 is electrically connected to the n-th stage driving signal output terminal GT(n), and the source of the first output reset transistor TF1 is electrically connected to the first low level terminal VGL1.

A first terminal of the first third capacitor C13 is electrically connected to the first clock signal terminal CK1, and a second terminal of the first third capacitor C13 is electrically connected to the n-th stage second control node QB1(n).

A first terminal of the first first capacitor C11 is electrically connected to the n-th stage first node Q(n), and a second terminal of the first first capacitor C11 is electrically connected to the n-th stage carry signal output terminal CR(n).

A first terminal of the first second capacitor C12 is electrically connected to the n-th stage second node QB(n), and a second terminal of the first second capacitor C12 is electrically connected to the first low level terminal VGL1.

The “n” is a positive integer;

The (n+1)-th stage driving circuit includes a second first transistor T21, a second fourth transistor T24, a second fifth transistor T25, a second sixth transistor T26, a second seventh transistor T27, a second carry output transistor TR2, a second carry reset transistor TRF2, a second output transistor TS2, a second output reset transistor TF2, a second first capacitor C21, a second second capacitor C22, and a second third capacitor C23.

The gate of the second first transistor T21 is connected to the n-th stage first node Q(n), the drain of the second first transistor T21 is electrically connected to the n-th stage intermediate node P(n), and the source of the second first transistor T21 is electrically connected to the (n+1)-th stage second control node QB1(n+1).

The gate of the second fourth transistor T24 is electrically connected to the second clock signal terminal CK2, the drain of the second fourth transistor T24 is electrically connected to the n-th stage carry signal output terminal CR(n), and the source of the second fourth transistor T24 is electrically connected to the (n+1)-th stage first control node Q1(n+1).

The gate of the second fifth transistor T25 is electrically connected to the first high level terminal VGH1, the drain of the second fifth transistor T25 is electrically connected to the (n+1)-th stage first control node Q1(n+1), and the source of the second fifth transistor T25 is electrically connected to the (n+1)-th stage first node Q(n+1).

The gate of the second sixth transistor T26 is electrically connected to the (n+1)-th stage second control node QB1(n+1), the drain of the second sixth transistor T26 is electrically connected to the second clock signal terminal CK2, and the source of the second sixth transistor T26 is electrically connected to the (n+1)-th stage second node QB(n+1).

The gate of the second seventh transistor T27 is electrically connected to the (n+1)-th stage first control node Q1(n+1), the drain of the second seventh transistor T27 is electrically connected to the first low level terminal VGL1, and the source of the second seventh transistor T27 is electrically connected to the (n+1)-th stage second node QB(n+1).

The gate of the second carry output transistor TR2 is electrically connected to the (n+1)-th stage first node Q(n+1), the drain of the second carry output transistor TR2 is electrically connected to the first high level terminal VGH1, and the source of the second carry output transistor TR2 is electrically connected to the (n+1)-th stage carry signal output terminal CR(n+1).

The gate of the second carry reset transistor TRF2 is electrically connected to the (n+1)-th stage second node QB(n+1), the drain of the second carry reset transistor TRF2 is electrically connected to the (n+1)-th stage carry signal output terminal CR(n+1), and the source of the second carry reset transistor TRF2 is electrically connected to the first low level terminal VGL1.

The gate of the second output transistor TS2 is electrically connected to the (n+1)-th stage first node Q(n+1), the drain of the second output transistor TS2 is electrically connected to the first high level terminal VGH1, and the source of the second output transistor TS2 is electrically connected to the (n+1)-th stage driving signal output terminal GT(n+1).

The gate of the second output reset transistor TF2 is electrically connected to the (n+1)-th stage second node QB(n+1), the drain of the second output reset transistor TF2 is electrically connected to the (n+1)-th stage driving signal output terminal GT(n+1), and the source of the second output reset transistor TF2 is electrically connected to the first low level terminal VGL1.

A first terminal of the second third capacitor C23 is electrically connected to the second clock signal terminal CK2, and a second terminal of the second third capacitor C23 is electrically connected to the (n+1)-th stage second control node QB1(n+1).

A first terminal of the second first capacitor C21 is electrically connected to the (n+1)-th stage first node Q(n+1), and a second terminal of the second first capacitor C21 is electrically connected to the (n+1)-th stage carry signal output terminal CR(n+1).

A first terminal of the second second capacitor C22 is electrically connected to the (n+1)-th stage second node QB(n+1), and a second terminal of the second second capacitor C22 is electrically connected to the first low level terminal VGL1.

In at least one embodiment of the driving circuit shown in FIG. 24, in the n-th stage driving circuit, the control clock signal terminal is the first clock signal terminal, and in the (n+1)-th stage driving circuit, the control clock signal terminal is the second clock signal terminal.

In at least one embodiment of the driving circuit shown in FIG. 24, the n-th stage driving circuit and the (n+1)-th stage driving circuit share the n-th stage intermediate node P(n).

The difference of at least one embodiment of the driving circuit shown in FIG. 25 from at least one embodiment of the driving circuit shown in FIG. 22 lies in that:
the gate of the first transistor T1 and the gate of the second transistor T2 are both electrically connected to the first control node Q1(n−1) in the adjacent upper-stage driving circuit.

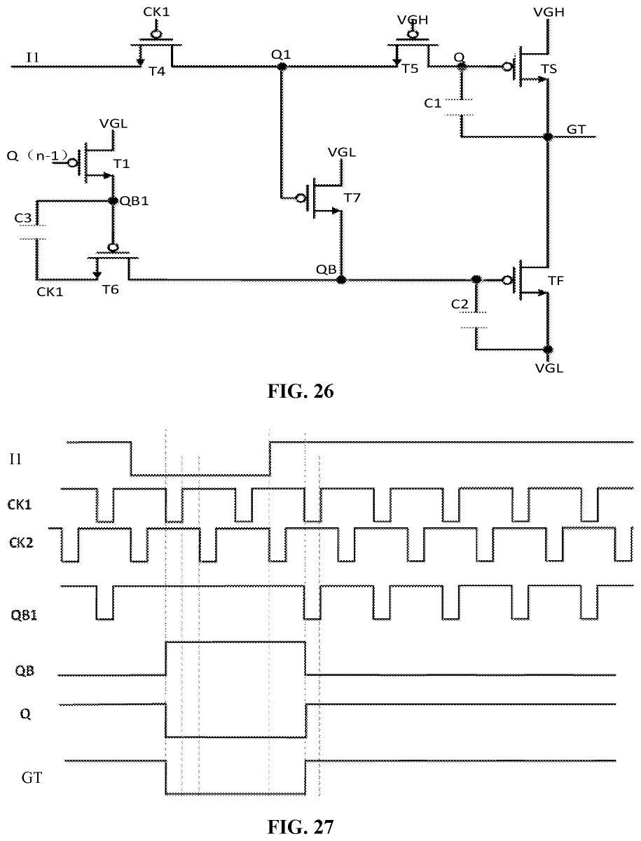

The difference of at least one embodiment of the driving circuit shown in FIG. 26 from at least one embodiment of the driving circuit shown in FIG. 17 lies in that: all transistors are P-type transistors.

FIG. 27 is a timing sequence diagram of at least one embodiment of the driving circuit shown in FIG. 26.

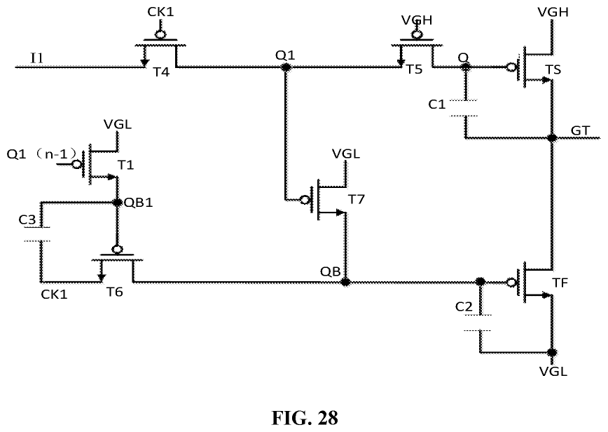

The difference of at least one embodiment of the driving circuit shown in FIG. 28 from at least one embodiment of the driving circuit shown in FIG. 26 lies in that: the gate of the first transistor T1 is electrically connected to the first control node Q1(n−1) in the (n−1)-th stage driving circuit.

The driving module according to the embodiment of the present disclosure includes multiple stages of the above-mentioned driving circuits.

In at least one embodiment of the present disclosure, the node control terminal of the a-th stage driving circuit is the first node in the (a-m)-th stage driving circuit or the first control node in the (a-m)-th stage driving circuit;

Both a and m are positive integers.

Optionally, the second control node control circuit in the n-th stage driving circuit includes an n-th stage first control circuit, an n-th stage second control circuit, and an n-th stage third control circuit, where n is a positive integer.

The second control node control circuit in the (n+1)-th stage driving circuit is electrically connected to the (n+1)-th node control terminal, the (n+1)-th stage second control node, and the n-th stage intermediate node, and is configured to control the connection between the (n+1)-th stage second control node and the adjacent upper-stage intermediate node under the control of the signal provided by the (n+1)-th node control terminal.

The n-th stage first control circuit is electrically connected to the n-th node control terminal, the third voltage terminal, and the n-th stage intermediate node, and is configured to control the connection between the n-th stage intermediate node and the third voltage terminal under the control of the signal provided by the n-th node control terminal.

The n-th stage second control circuit is electrically connected to the n-th node control terminal, the n-th stage intermediate node, and the n-th stage second control node, and is configured to control the connection between the n-th stage intermediate node and the n-th stage second control node under the control of the signal provided by the n-th node control terminal.

The n-th stage third control circuit is electrically connected to the n-th stage second control node, the n-th stage intermediate node, and the fourth voltage terminal, and is configured to control the connection between the n-th stage intermediate node and the fourth voltage terminal under the control of the n-th stage second control node.

A driving method according to an embodiment of the present disclosure is applied to the above-mentioned driving circuit, and the driving method includes:
the first control node control circuit controls the connection between the first control node and the input terminal under the control of the control clock signal;
the first node control circuit controls the connection between the first control node and the first node under the control of the first voltage signal;
the second control node control circuit controls the potential of the second control node under the control of the potential of the first node in the adjacent upper m-stage driving circuit or the first control node in the adjacent upper m-stage driving circuit, where m is a positive integer; and
the second node control circuit controls the potential of the second node according to the control clock signal under the control of the second control node.

In at least one embodiment of the present disclosure, the step in which the second control node control circuit controls the potential of the second control node under the control of the potential of the first node in the adjacent upper m-stage driving circuit or the first control node in the adjacent upper m-stage driving circuit includes:
the second control node control circuit controls the connection between the second control node and the second voltage terminal or the adjacent upper-stage intermediate node under the control of the potential of the first node in the adjacent upper m-stage driving circuit or the first control node in the adjacent upper m-stage driving circuit.

Optionally, the second control node control circuit includes a first control circuit, a second control circuit, and a third control circuit; the step in which the second control node control circuit controls the potential of the second control node under the control of the potential of the first node in the adjacent upper m-stage driving circuit or the first control node in the adjacent upper m-stage driving circuit includes:
the first control circuit controls the connection between the intermediate node and the third voltage terminal under the control of the potential of the first node in the adjacent upper m-stage driving circuit or the first control node in the adjacent upper m-stage driving circuit;
the second control circuit controls the connection between the intermediate node and the second control node under the control of the potential of the first node in the adjacent upper m-stage driving circuit or the first control node in the adjacent upper m-stage driving circuit; and
the third control circuit controls the connection between the intermediate node and the fourth voltage terminal under the control of the second control node.

In at least one embodiment of the present disclosure, the driving circuit further includes an output circuit and an output reset circuit; the driving method further includes:
the output circuit controls the connection between the driving signal output terminal and the first voltage terminal under the control of the first node;
the output reset circuit controls the connection between the driving signal output terminal and the second voltage terminal under the control of the second node; and
the second node control circuit controls the potential of the second node under the control of the first node.

The display device according to the embodiment of the present disclosure includes the above-mentioned driving module.

The above descriptions are some preferred implementations of the present disclosure. It should be noted that for those of ordinary skill in the art, various optimizations and enhancements can still be made without departing from the principles of the present disclosure, and these optimizations and enhancements should also fall into the protection scope of the present disclosure.

1. A driving circuit, comprising a first control node control circuit, a first node control circuit, a second control node control circuit, and a second node control circuit, wherein,
the first control node control circuit is electrically connected to a control clock signal terminal, an input terminal, and a first control node, and is configured to control connection between the first control node and the input terminal under control of a control clock signal provided by the control clock signal terminal,
the first node control circuit is electrically connected to a first voltage terminal, the first control node, and a first node, and is configured to control connection between the first control node and the first node under control of a first voltage signal provided by the first voltage terminal,
the second control node control circuit is electrically connected to a node control terminal and a second control node, and is configured to control a potential of the second control node under control of a signal provided by the node control terminal; the node control terminal is a first node in an adjacent upper m-stage driving circuit or a first control node in the adjacent upper m-stage driving circuit, wherein m is a positive integer, and
the second node control circuit is electrically connected to the second control node, the control clock signal terminal, and a second node, and is configured to control a potential of the second node according to the control clock signal provided by the control clock signal terminal under control of the second control node.

2. The driving circuit according to claim 1, wherein the second control node control circuit is further electrically connected to a second voltage terminal or an adjacent upper-stage intermediate node, and is configured to control connection between the second control node and the second voltage terminal or the adjacent upper-stage intermediate node under control of the signal provided by the node control terminal.

3. The driving circuit according to claim 2, wherein the second control node control circuit comprises a first transistor, and
a gate of the first transistor is electrically connected to the node control terminal, a first electrode of the first transistor is electrically connected to the second voltage terminal or the adjacent upper-stage intermediate node, and a second electrode of the first transistor is electrically connected to the second control node.

4. The driving circuit according to claim 1, wherein the second control node control circuit comprises a first control circuit, a second control circuit, and a third control circuit,
the first control circuit is electrically connected to the node control terminal, a third voltage terminal, and an intermediate node, and is configured to control connection between the intermediate node and the third voltage terminal under control of the signal provided by the node control terminal,
the second control circuit is electrically connected to the node control terminal, the intermediate node, and the second control node, and is configured to control connection between the intermediate node and the second control node under control of the signal provided by the node control terminal, and
the third control circuit is electrically connected to the second control node, the intermediate node, and a fourth voltage terminal, and is configured to control connection between the intermediate node and the fourth voltage terminal under control of the second control node.

5. The driving circuit according to claim 4, wherein the first control circuit comprises a first transistor, the second control circuit comprises a second transistor, and the third control circuit comprises a third transistor,
a gate of the first transistor is electrically connected to the node control terminal, a first electrode of the first transistor is electrically connected to the third voltage terminal, and a second electrode of the first transistor is electrically connected to the intermediate node,
a gate of the second transistor is electrically connected to the node control terminal, a first electrode of the second transistor is electrically connected to the intermediate node, and a second electrode of the second transistor is electrically connected to the second control node, and
a gate of the third transistor is electrically connected to the second control node, a first electrode of the third transistor is electrically connected to the fourth voltage terminal, and a second electrode of the third transistor is electrically connected to the intermediate node.

6. The driving circuit according to claim 1, further comprising an output circuit and an output reset circuit, wherein,
the output circuit is electrically connected to the first node, a driving signal output terminal, and the first voltage terminal, and is configured to control connection between the driving signal output terminal and the first voltage terminal under control of the first node,
the output reset circuit is electrically connected to the second node, the driving signal output terminal, and the second voltage terminal, and is configured to control connection between the driving signal output terminal and the second voltage terminal under control of the second node;
wherein the output circuit comprises an output transistor, and the output reset circuit comprises an output reset transistor.
a gate of the output transistor is electrically connected to the first node, a first electrode of the output transistor is electrically connected to the first voltage terminal, and a second electrode of the output transistor is electrically connected to the driving signal output terminal, and
a gate of the output reset transistor is electrically connected to the second node, a first electrode of the output reset transistor is electrically connected to the driving signal output terminal, and a second electrode of the output reset transistor is electrically connected to the second voltage terminal.

7. The driving circuit according to claim 1, further comprising a carry output circuit, a carry reset circuit, an output circuit, and an output reset circuit, wherein,
the carry output circuit is electrically connected to the first node, a carry signal output terminal, and the first voltage terminal, and is configured to control connection between the carry signal output terminal and the first voltage terminal under control of the first node,
the carry reset circuit is electrically connected to the second node, the carry signal output terminal, and the second voltage terminal, and is configured to control connection between the carry signal output terminal and the second voltage terminal under control of the second node,
the output circuit is electrically connected to the first node, a driving signal output terminal, and a fifth voltage terminal, and is configured to control connection between the driving signal output terminal and the fifth voltage terminal under control of the first node, and
the output reset circuit is electrically connected to the second node, the driving signal output terminal, and a sixth voltage terminal, and is configured to control connection between the driving signal output terminal and the sixth voltage terminal under control of the second node.

8. The driving circuit according to claim 1, wherein the second node control circuit is further electrically connected to the first control node, and is configured to control the potential of the second node under control of the first control node,
the driving circuit further comprises a control energy storage circuit, and
the control energy storage circuit is electrically connected to the control clock signal terminal and the second control node, and is configured to control the potential of the second control node according to the control clock signal;
wherein the second node control circuit comprises a sixth transistor and a seventh transistor,
a gate of the sixth transistor is electrically connected to the second control node, a first electrode of the sixth transistor is electrically connected to the control clock signal terminal, and a second electrode of the sixth transistor is electrically connected to the second node, and
a gate of the seventh transistor is electrically connected to the first control node, a first electrode of the seventh transistor is electrically connected to the second voltage terminal, and a second electrode of the seventh transistor is electrically connected to the second node.

9. The driving circuit according to claim 7, further comprising a first energy storage circuit and a second energy storage circuit, wherein,
a first terminal of the first energy storage circuit is electrically connected to the first node, a second terminal of the first energy storage circuit is electrically connected to the driving signal output terminal, and the first energy storage circuit is configured to store electrical energy, and
the second energy storage circuit is electrically connected to the second node, and the second energy storage circuit is configured to maintain the potential of the second node.

10. The driving circuit according to claim 7, further comprising a first energy storage circuit and a second energy storage circuit, wherein,
a first terminal of the first energy storage circuit is electrically connected to the first node, a second terminal of the first energy storage circuit is electrically connected to the carry signal output terminal, and the first energy storage circuit is configured to store electrical energy, and
the second energy storage circuit is electrically connected to the second node, and the second energy storage circuit is configured to maintain the potential of the second node.

11. The driving circuit according to claim 1, wherein the first control node control circuit comprises a fourth transistor, and the first node control circuit comprises a fifth transistor,
a gate of the fourth transistor is electrically connected to the control clock signal terminal, a first electrode of the fourth transistor is electrically connected to the input terminal, and a second electrode of the fourth transistor is electrically connected to the first control node, and
a gate of the fifth transistor is electrically connected to the first voltage terminal, a first electrode of the fifth transistor is electrically connected to the first control node, and a second electrode of the fifth transistor is electrically connected to the first node.

12.-13. (canceled)

14. The driving circuit according to claim 7, wherein the carry output circuit comprises a carry output transistor, the carry reset circuit comprises a carry reset transistor, the output circuit comprises an output transistor, and the output reset circuit comprises an output reset transistor,
a gate of the carry output transistor is electrically connected to the first node, a first electrode of the carry output transistor is electrically connected to the first voltage terminal, and a second electrode of the carry output transistor is electrically connected to the carry signal output terminal,
a gate of the carry reset transistor is electrically connected to the second node, a first electrode of the carry reset transistor is electrically connected to the carry signal output terminal, and a second electrode of the carry reset transistor is electrically connected to the second voltage terminal,
a gate of the output transistor is electrically connected to the first node, a first electrode of the output transistor is electrically connected to the fifth voltage terminal, and a second electrode of the output transistor is electrically connected to the driving signal output terminal, and
a gate of the output reset transistor is electrically connected to the second node, a first electrode of the output reset transistor is electrically connected to the driving signal output terminal, and a second electrode of the output reset transistor is electrically connected to the sixth voltage terminal.

15. A driving module, comprising multiple stages of driving circuits according to claim 1.

16. The driving module according to claim 15, wherein a node control terminal of an a-th stage driving circuit is a first node in an (a-m)-th stage driving circuit or a first control node in the (a-m)-th stage driving circuit, and
both a and m are positive integers.

17. The driving module according to claim 15, wherein a second control node control circuit in an n-th stage driving circuit comprises an n-th stage first control circuit, an n-th stage second control circuit, and an n-th stage third control circuit, n is a positive integer,
a second control node control circuit in an (n+1)-th stage driving circuit is electrically connected to an (n+1)-th node control terminal, an (n+1)-th stage second control node, and an n-th stage intermediate node, and is configured to control connection between the (n+1)-th stage second control node and an adjacent upper-stage intermediate node under control of a signal provided by the (n+1)-th node control terminal,
the n-th stage first control circuit is electrically connected to an n-th node control terminal, a third voltage terminal, and the n-th stage intermediate node, and is configured to control connection between the n-th stage intermediate node and the third voltage terminal under control of a signal provided by the n-th node control terminal,
the n-th stage second control circuit is electrically connected to the n-th node control terminal, the n-th stage intermediate node, and an n-th stage second control node, and is configured to control connection between the n-th stage intermediate node and the n-th stage second control node under control of the signal provided by the n-th node control terminal, and
the n-th stage third control circuit is electrically connected to the n-th stage second control node, the n-th stage intermediate node, and a fourth voltage terminal, and is configured to control connection between the n-th stage intermediate node and the fourth voltage terminal under control of the n-th stage second control node.

18. A driving method, applied to the driving circuit according to claim 1, the driving method comprising:
controlling, by the first control node control circuit, connection between the first control node and the input terminal under control of the control clock signal;
controlling, by the first node control circuit, connection between the first control node and the first node under control of the first voltage signal;
controlling, by the second control node control circuit, the potential of the second control node under control of a potential of the first node in the adjacent upper m-stage driving circuit or the first control node in the adjacent upper m-stage driving circuit, wherein m is a positive integer; and
controlling, by the second node control circuit, the potential of the second node according to the control clock signal under control of the second control node.

19. The driving method according to claim 18, wherein the step of controlling, by the second control node control circuit, the potential of the second control node under control of the potential of the first node in the adjacent upper m-stage driving circuit or the first control node in the adjacent upper m-stage driving circuit comprises:
controlling, by the second control node control circuit, connection between the second control node and the second voltage terminal or the adjacent upper-stage intermediate node under control of the potential of the first node in the adjacent upper m-stage driving circuit or the first control node in the adjacent upper m-stage driving circuit.

20. The driving method according to claim 18, wherein the second control node control circuit comprises a first control circuit, a second control circuit, and a third control circuit, and the step of controlling, by the second control node control circuit, the potential of the second control node under control of the potential of the first node in the adjacent upper m-stage driving circuit or the first control node in the adjacent upper m-stage driving circuit comprises:
controlling, by the first control circuit, connection between the intermediate node and the third voltage terminal under control of the potential of the first node in the adjacent upper m-stage driving circuit or the first control node in the adjacent upper m-stage driving circuit;
controlling, by the second control circuit, connection between the intermediate node and the second control node under control of the potential of the first node in the adjacent upper m-stage driving circuit or the first control node in the adjacent upper m-stage driving circuit;
and controlling, by the third control circuit, connection between the intermediate node and the fourth voltage terminal under control of the second control node.

21. The driving method according to claim 18, wherein the driving circuit further comprises an output circuit and an output reset circuit, and the driving method further comprises:
controlling, by the output circuit, connection between the driving signal output terminal and the first voltage terminal under control of the first node;
controlling, by the output reset circuit, connection between the driving signal output terminal and the second voltage terminal under control of the second node; and
controlling, by the second node control circuit, the potential of the second node under control of the first node.

22. A display device, comprising the driving module according to claim 15.
